(19) United States
(12) Patent Application Publication
(10) Pub. No.: US 2026/0321124 A1
(43) Pub. Date: Oct. 15, 2026

(54) METHODS AND APPARATUS FOR DETECTING AND MANAGING AN UNSAFE CONDITION IN A BUILDING

(71) Applicant: Atlas Sound LP

(72) Inventors: Johnathan Ivey, Chandler, AZ (US); Brandon Graham, Sandy, UT (US); Shawn Morgan, Goshen, KY (US); Jonathan Stembel, Goshen, IN (US); Kristiyan Georgiev, Louisville, KY (US)

(73) Assignee: Atlas Sound LP, Phoenix, AZ (US)

(21) Appl. No.: 19/573,428

(22) Filed: Mar. 20, 2026

Related U.S. Application Data
(60) Provisional application No. 63/785,989, filed on Apr. 9, 2025.
(60) Provisional application No. 63/891,257, filed on Sep. 30, 2025.

(51) Int. Cl. G08B 25/00; G08B 7/06; G08B 21/02; G08B 21/18; G08B 25/10

(52) U.S. Cl. CPC G08B 25/009; G08B 7/06; G08B 21/02; G08B 21/182; G08B 25/10

(57) ABSTRACT

Methods, apparatus, systems, and articles of manufacture for detecting and managing an unsafe condition in a building are disclosed that, where the safety system is in communication with at least one personnel information system that includes an occupant database, the at least one personnel information system operable to transmit a portion of occupant data from the occupant database to at least one external device, the system includes an endpoint device to transmit an unsafe condition status to the at least one personnel information system based on detection of an unsafe condition, wherein the unsafe condition status causes the at least one personnel information system to transmit the portion of occupant data from the occupant database to the at least one external device.

### CROSS-REFERENCE TO RELATED APPLICATIONS

This disclosure claims the benefit of priority under 35 U.S. C § 119(e) to U.S. Provisional Patent Application No. 63/785,989, filed on Apr. 9, 2025, and titled “METHODS AND APPARATUS FOR DETECTING AND MANAGING AN UNSAFE CONDITION IN A BUILDING,” and to U.S. Provisional Patent Application No. 63/891,257, filed on Sep. 30, 2025, and titled “UNSAFE CONDITION DETECTORS.” The entire contents of each of the forgoing applications are hereby incorporated by reference in their entirety for all purposes.

### FIELD OF THE DISCLOSURE

This disclosure relates generally to endpoint devices, and more specifically to methods and apparatus for detecting and managing an unsafe condition in a building.

### BACKGROUND

Unsafe conditions can occur in buildings where the existence of the unsafe conditions threatens human life and/or property. Examples of unsafe conditions may include an intruder (e.g., an armed intruder, such as an intruder with a gun, an intruder with a knife, and/or the like, an unauthorized person, and/or the like), a fire, a tornado, a flood, a power outage, and other dangerous occurrences which may threaten human life and/or property. Time and information are valuable resources in mitigation of the unsafe conditions.

### SUMMARY

In some aspects, a safety system is provided. The safety system is in communication with at least one personnel information system that includes an occupant database. The at least one personnel information system is operable to transmit a portion of occupant data from the occupant database to at least one external device. The safety system includes an endpoint device. The endpoint device may transmit an unsafe condition status to the at least one personnel information system based on detection of an unsafe condition. The unsafe condition status may cause the at least one personnel information system to transmit the portion of occupant data from the occupant database to the at least one external device.

The endpoint device may include a plurality of sensors that are operable to detect the unsafe condition. The endpoint device may be operable to transmit the unsafe condition status in response to at least one of the plurality of sensors detecting the unsafe condition. The endpoint device may use a first one of the plurality of sensors to generate a first confidence score. The endpoint device may use a second one of the plurality of sensors to generate a second confidence score. The first confidence score may be underneath a first positive detection threshold. The second confidence score may be underneath a second positive detection threshold. If the first confidence score is underneath a first positive detection threshold and the second confidence score is underneath a second positive detection threshold, the endpoint device may use a combination of the first confidence score and the second confidence score to result in a positive detection.

The endpoint device may include an unsafe condition action plan database. The unsafe condition action plan database may stores lockdown protocol information. The endpoint device may classify the unsafe condition to generate an unsafe condition classification. Based on the unsafe condition classification, the endpoint device may obtain a corresponding lockdown protocol action plan from the unsafe condition action plan database. The lockdown protocol action plan may include instructions for operating peripheral devices of the endpoint device and may include instructions for causing the endpoint device to transmit the unsafe condition status.

The safety system may be installed in a building. The safety system may includes the at least one personnel information system. The occupant data may include information corresponding to a quantity of occupants in the building, an identity of occupants in the building, and an expected location of occupants in the building. The endpoint device may be configured to, in response to detection of the unsafe condition, query the at least one personnel information system for at least some of the occupant data in the occupant database.

The endpoint device may be a first endpoint device. The safety system may further include a second endpoint device. The detection of the unsafe condition may be performed by the second endpoint device. The safety system may be installed in a building. The first endpoint device may be located in a first room in the building. The second endpoint device may be located in a second room in the building. The endpoint device may include a display. The endpoint device may include an auditory speaker. The endpoint device may include a visual light video-camera. The endpoint device may include a non-imaging visual light sensor. The endpoint device may include a first microphone operable to detect human speech. The endpoint device may include a second microphone operable to detect sounds in a decibel range higher than a decibel range associated with human speech. The endpoint device may include an infrared-light video-camera. The endpoint device may include a non-imaging infrared light sensor. The endpoint device may include a particulate matter detector. The endpoint device may include a clock. The endpoint device may include a flasher. The endpoint device may include a thermal camera. The endpoint device may include a thermometer. The endpoint device may include a smoke detector. The endpoint device may include an occupancy detector.

The safety system of claim 1 may include a wireless communication router in communication with the endpoint device. The endpoint device may be operable to command the wireless communication router to establish a wireless network based on detection of an unsafe condition. The wireless communication router may transmit video based on the detection of the unsafe condition.

In other aspects, an apparatus is provided. The apparatus may be installed in a building. The building may have a personnel information system. The apparatus may include at least one sensor to generate sensor data. The apparatus may include unsafe condition monitoring circuitry. The unsafe condition monitoring circuitry may determine that an unsafe condition is present in the building. The unsafe condition monitoring circuitry may determine that an unsafe condition is present in the building based at least in part on sensor data. The apparatus may include a network interface. The network interface may transmit an alert to the personnel information system. The apparatus may further include an auditory speaker and peripheral activation circuitry. The peripheral activation circuitry may activate an auditory alarm with the auditory speaker. The peripheral activation circuitry may activate the auditory alarm based on a determination that the unsafe condition is present in the building. The apparatus may further include a flasher, an internal front display, and peripheral activation circuitry. The peripheral activation circuitry may activate a visual alarm with the flasher. The peripheral activation circuitry may activate the visual alarm based on the determination that the unsafe condition is present in the building. The peripheral activation circuitry may activate a text-based alarm with the internal front display. The peripheral activation circuitry may activate the text-based alarm based on the determination that the unsafe condition is present in the building.

The alert may instruct the personnel information system to transmit occupant data to at least one external device. The apparatus may include door locking circuitry. The door locking circuitry is to transmit a door locking instruction that is operable to cause locking of remotely lockable doors.

In yet other aspects, an apparatus is provided. The apparatus may be installed in a building. The apparatus may include an occupant database. The occupant database may store occupant information. The occupant information may include information relating to a quantity of occupants in the building, an identity of occupants in the building, and an expected location of occupants in the building. The apparatus may include a network interface. The network interface may transmit a portion of the occupant information to at least one external device. The apparatus may include door locking circuitry operable to lock or unlock remotely lockable doors in the building. The at least one external device may include a first external device and a second external device. The apparatus may transmit a first data message to the first external device and the apparatus may transmit a second data message to the second external device.

The network interface may use a location signal of the at least one external device. The network interface may use the location signal to determine if the at least one external device is an on-premise external device that is located within the building or an off-premise external device that is located outside of the building.

The building may include at least one endpoint device. The at least one endpoint device may be operable to send a query corresponding to information regarding a total quantity of occupants in the building. The network interface may receive the query. The quantity of occupants in the building may include the total quantity of occupants in the building. The network interface may transmit the portion of the occupant information through at least a subset of a plurality of channels. The plurality of channels may include a text message channel. The plurality of channels may include an email channel. The plurality of channels may include a social media channel. The plurality of channels may include a cellular phone call channel. The plurality of channels may include an internet phone call channel. The plurality of channels may include a user application notification channel.

### BRIEF DESCRIPTION OF DRAWINGS

FIG. 1 is a block diagram of an example safety system that includes an endpoint device.

FIG. 2 is a block diagram of the endpoint device of FIG. 1.

FIG. 3 is a block diagram of peripheral devices that may associated with the endpoint device of FIG. 1.

FIG. 4 is a physical representation of one implementation of the endpoint device of FIG. 1.

FIG. 5 is a physical representation of one implementation of an unsafe condition detection module that may be connected to the endpoint device of FIG. 1.

FIG. 6 illustrates a user interface operable to allow an electronic device to access video data of a building after an unsafe condition is detected in the building.

FIG. 7 is a flowchart representative of example machine-readable instructions and/or example operations that may be executed, instantiated, and/or performed by example programmable circuitry to implement the example endpoint device of FIG. 1 to transmit at least one alert to a personnel information system.

FIG. 8 is a flowchart representative of example machine-readable instructions and/or example operations that may be executed, instantiated, and/or performed by example programmable circuitry to implement the safety system of FIG. 1 to detect an unsafe condition and transmit occupant data to at least one of a plurality of external devices.

FIG. 9 is a flowchart representative of example machine-readable instructions and/or example operations that may be executed, instantiated, and/or performed by example programmable circuitry to implement the endpoint device of FIG. 1 to perform different tiered actions based on an associated confidence level of the detection of the unsafe condition.

FIG. 10 is a flowchart representative of example machine-readable instructions and/or example operations that may be executed, instantiated, and/or performed by example programmable circuitry to implement the endpoint device of FIG. 1 to adjust an escalation timer based on the type of the detection.

FIG. 11 is a flowchart representative of example machine-readable instructions and/or example operations that may be executed, instantiated, and/or performed by example programmable circuitry to implement the endpoint device of FIG. 1 to simultaneously monitor the environment with a plurality of unsafe condition detectors.

FIG. 12 is a flowchart representative of example machine-readable instructions and/or example operations that may be executed, instantiated, and/or performed by example programmable circuitry to implement the endpoint device of FIG. 1 to monitor the environment with audio detectors.

FIG. 13 is a flowchart representative of example machine-readable instructions and/or example operations that may be executed, instantiated, and/or performed by example programmable circuitry to implement the endpoint device of FIG. 1 to monitor the environment with light detectors.

FIG. 14 is a block diagram of an example programmable circuitry platform structured to execute and/or instantiate both the example machine-readable instructions and/or the example operations of FIGS. 7-13 to implement the processor of the endpoint device of FIG. 1.

FIG. 15 is a block diagram of an example implementation of the programmable circuitry platform of FIG. 14.

FIG. 16 is a block diagram of another example implementation of the programmable circuitry platform of FIG. 14.

FIG. 17 is a block diagram of an example software distribution platform to distribute software, instructions, and/or firmware to client devices and/or hardware platforms.

In general, the same reference numbers will be used throughout the drawing(s) and accompanying written description to refer to the same or like parts. The figures are not necessarily to scale.

Before any example configurations of the disclosure are explained in detail, it is to be understood that the disclosure is not limited in its application to the details of construction and the arrangement of components set forth in the following description or illustrated in the accompanying drawings. The disclosure is capable of other configurations and of being practiced or of being carried out in various ways. Also, it is to be understood that the phraseology and terminology used herein is for the purpose of description and should not be regarded as limiting.

For the purposes of promoting an understanding of the principles of the disclosure, reference will now be made to the examples illustrated in the drawing(s), and specific language will be used to describe the same. It will nevertheless be understood that no limitation of the scope of the disclosure is thereby intended. Any alterations and further modifications of the features illustrated herein, and any additional applications of the principles of the disclosure as illustrated herein, which would occur to one skilled in the relevant art and having possession of this disclosure, are to be considered within the scope of the disclosure.

### DETAILED DESCRIPTION

While building alarms and danger detectors have been used in the past, it is desired to provide a system which is able to transmit specific information from the building to first responders (e.g., law enforcement, police officers, firefighters, nurses, etc.) quickly and efficiently to allow the first responders to prioritize their aid. Certain buildings may be equipped with databases that provide information about the building personnel. While first responders will attempt to rescue building personnel, first responders typically do not have access to information and data regarding the building personnel at the beginning of the unsafe condition. Such access would be useful to assist first responders in prioritizing the rescue. For example, certain building personnel may be absent from the building during the occurrence of the unsafe condition and therefore, first responders could waste time and resources in searching for a missing person who is perfectly safe at a different location.

Some implementations herein provide a safety system that is to include a personnel information system accessible by an administration device, an endpoint device, and at least one external device. The safety system is to, based on a detection of an unsafe condition by the endpoint device or another source, transmit an unsafe condition status to the personnel information system. By transmitting the unsafe condition status, the endpoint device reduces the time from the beginning of when the unsafe condition is detected and acknowledgement by the personnel information system. Based on receiving the unsafe condition status, the personnel information system is to transmit a portion of occupant data from an occupant database to the at least one external device. By transmitting the portion of occupant data, the personnel information system provides useful information to the user of the at least one external device such as the first responders. In other words, the safety system is capable of autonomously (e.g., without human aid or involvement) providing more time and information to first responders from the beginning of detection of the unsafe condition.

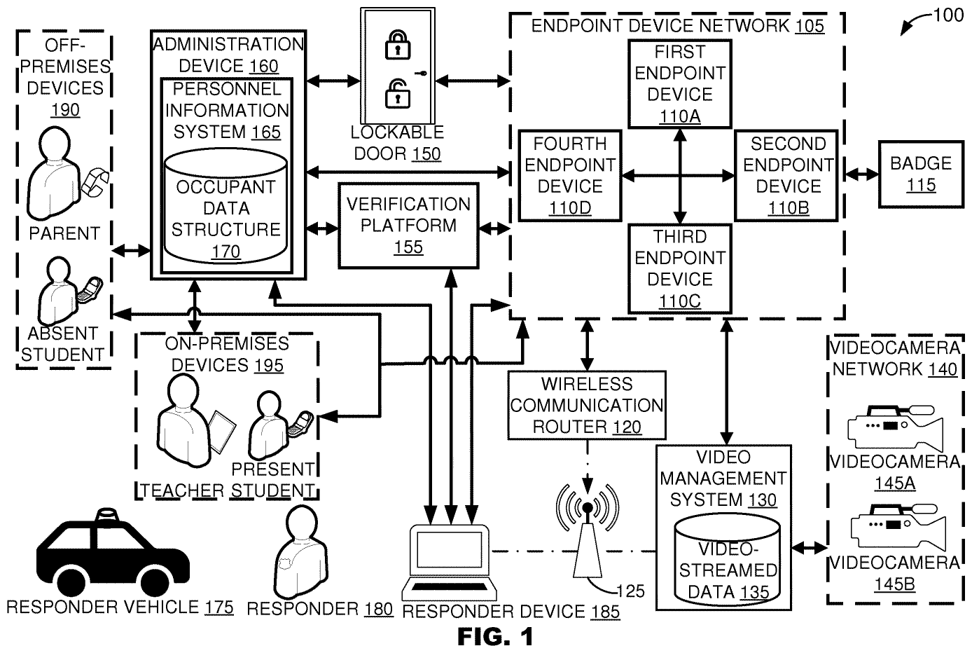

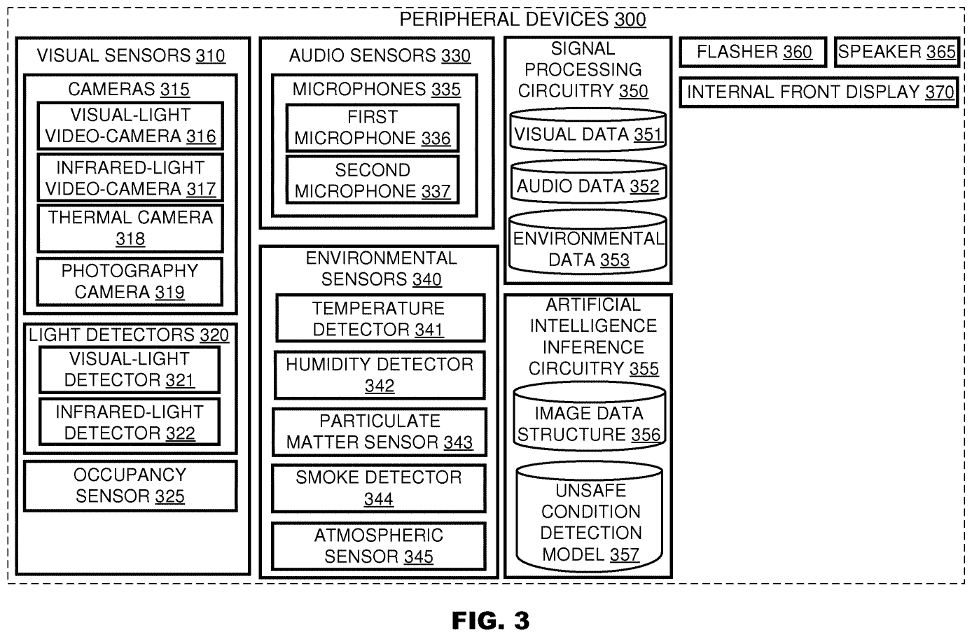

FIG. 1 is a block diagram of an example safety system 100 that includes an endpoint device network 105. As illustrated in the example of FIG. 1, the endpoint device network 105 includes a first endpoint device 110A, a second endpoint device 110B, a third endpoint device 110C, and a fourth endpoint device 110D. Although FIG. 1 depicts the endpoint device network 105 as having four endpoint devices 110A, 110B, 110C, 110D illustrated in FIG. 1, the endpoint device network 105 may have significantly more endpoint devices (e.g., thirty endpoint devices, one hundred endpoint devices, five hundred endpoint devices, etc.). In some examples, the first endpoint device 110A is located in a first room in the building and the second endpoint device 110B is located in a second room in the building. In some examples, the first endpoint device 110A may detect an unsafe condition and operate associated peripheral devices 300 (FIG. 3) based on the detection of the unsafe condition. In other examples, the second endpoint device 110B may detect the unsafe condition and cause the first endpoint device 110A to operate the associated peripheral devices 300 (FIG. 3).

The endpoint devices 110A, 110B, 110C, 110D of the endpoint device network 105 are connected to a badge 115. The badge 115 may be operated by an individual in the building and if the individual determines that an unsafe condition is present, the individual may press a button on the badge 115 which transmits a notification to an endpoint device 110 of the endpoint device network 105. The endpoint device 110 that receives the notification may activate certain peripherals devices 300 based on the notification and/or provide the notification to at least one of a verification platform 155, an administration device 160, and the responder device 185.

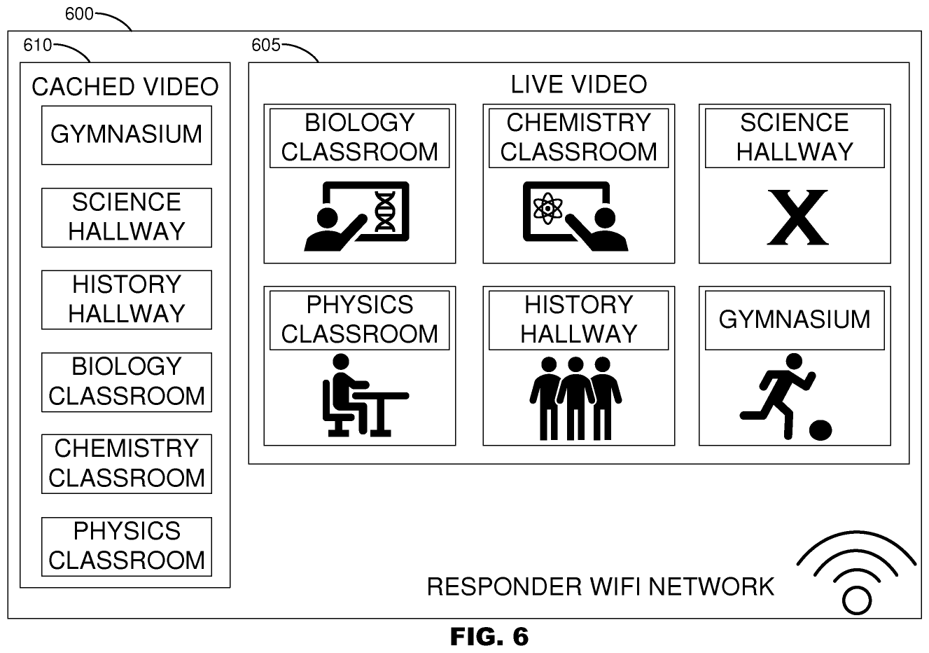

The endpoint devices 110A, 110B, 110C, 110D of the endpoint device network 105 are connected to a wireless communication router 120. When activated by an endpoint device 110, the wireless communication router 120 generates a responder Wi-Fi network 125 which may be accessible by a responder device 185. For example, the endpoint device 110 is operable to command the wireless communication router 120 to establish a wireless network such as the responder Wi-Fi network 125 based on the detection of an unsafe condition. By establishing the responder Wi-Fi network 125, the wireless communication router 120 is to transmit video based on the detection of the unsafe condition. The responder 180 (e.g., police officer, fire-fighter, paramedic, etc.) may operate the responder device 185 to access the responder Wi-Fi network 125 which provides access to a video management system 130 as described in connection with FIG. 6. The video management system 130 includes video-streamed data 135 which has been generated by the first videocamera 145A and the second videocamera 145B of the videocamera network 140. The video management system 130 may be implemented by the BlueIris™ video system.

The endpoint device network 105 is connected to a lockable door 150. The lockable door 150 may be electronically controlled. For example, the endpoint device 110 may transmit a door locking instruction that is operable to cause locking of the lockable door 150 that is in an unlocked state. Alternatively, the endpoint device 110 may transmit a door unlocking instruction that is operable to cause unlocking of the lockable door 150 that is in a locked state. Additionally, the administration device 160 may include circuitry operable to lock or unlock remotely lockable doors in the building such as the lockable door 150. In some examples, the endpoint device 110 transmits the door operation instruction (e.g., door unlocking instruction, door locking instruction, etc.) to the administration device 160 which provides the door operation instruction to the lockable door 150.

The endpoint device network 105 is connected to a verification platform 155. The example verification platform 155 may be implemented as a cloud-based service capable of validating unsafe condition detections. One such provider is RAPIDSOS®. For example, the verification platform 155 determines if the endpoint device 110 is accurate regarding the unsafe condition detection. In some examples, the endpoint device 110 determines that there is an unsafe condition is present in sensor data, and the verification platform 155 determines that an unsafe condition is not present in the sensor data identified by the endpoint device 110.

The endpoint device network 105 is connected to an administration device 160. The example administration device 160 may be operable by an individual in the building. The administration device 160 may be implemented as a central server operable to communicate with various individual device networks located throughout the building. For example, the administration device 160 broadcasts messages (e.g., announcements, notifications, alerts, etc.) to the endpoint device network 105, the responder device 185, the off-premises devices 190, and the on-premises devices 195. For example, administration device 160, based on the connection to the personnel information system 165, has contact information (e.g., phone numbers, email addresses, social media profiles, etc.) of building personnel and individuals associated with the building personnel.

The administration device 160 may include a personnel information system 165 that may be implemented as a cloud-based service capable of managing personnel data. For example, if the building is a school, the personnel data may correspond to teachers, students, parents, and staff. For example, if the building is an airport, the personnel data may correspond to pilots, passengers, and security guards. For example, if the building is a convention center, the personnel data may correspond to presenters, vendors, and attendees. In the context of the present disclosure, the techniques disclosed herein are described in the context of a school. Therefore, the personnel information system 165 may include an occupant database 170. One such provider of a personnel information system 165 in the context of a school is SKYWARD®.

The example occupant database 170 is a specific implementation of a data structure. Data structures include, in addition to relational databases and NoSQL databases, primitive data structures (e.g., integers, floats, characters, Boolean values, etc.), linear non-primitive data structures (e.g., array, stack, queue, linked list etc.), non-linear non-primitive data structure (e.g., tree, graph, hash table, binary tree, etc.), and formats such as .json, yml, or any plain text file format. The occupant database 170 may include occupant data such as information corresponding to a quantity of occupants in the building (e.g., four hundred students are in the building), an identity of occupants in the building (e.g., one of the students is named Johnny), and an expected location of occupants in the building (e.g., Johnny is currently expected to be in math class at 9:05 AM). A first portion of the occupant data may be secured (e.g., social security number, home address, etc.), while another portion of the occupant data may be unsecured (e.g., attendance data, name data, expected location data etc.).

The endpoint device 110 may transmit an unsafe condition status to the personnel information system 165 of the administration device 160. By transmitting the unsafe condition status, the endpoint device 110 causes the at least one personnel information system 165 to transmit a portion of occupant data from the occupant database 170 to at least one external device such as the lockable door 150, the responder device 185, the off-premises devices 190, and/or the on-premises devices 195. In other words, the example endpoint device 110 transmits an alert to the personnel information system 165 that is to instruct the personnel information system to transmit occupant data to at least one external device. In some examples, prior to transmitting the portion of occupant data, the administration device 160 transmits the data corresponding to the alert to the verification platform 155. In such examples, the verification platform may validate the unsafe condition detection and then cause the administration device 160 which houses the personnel information system 165 to obtain personnel data from the occupant database 170 and send the obtained personnel data to the external devices.

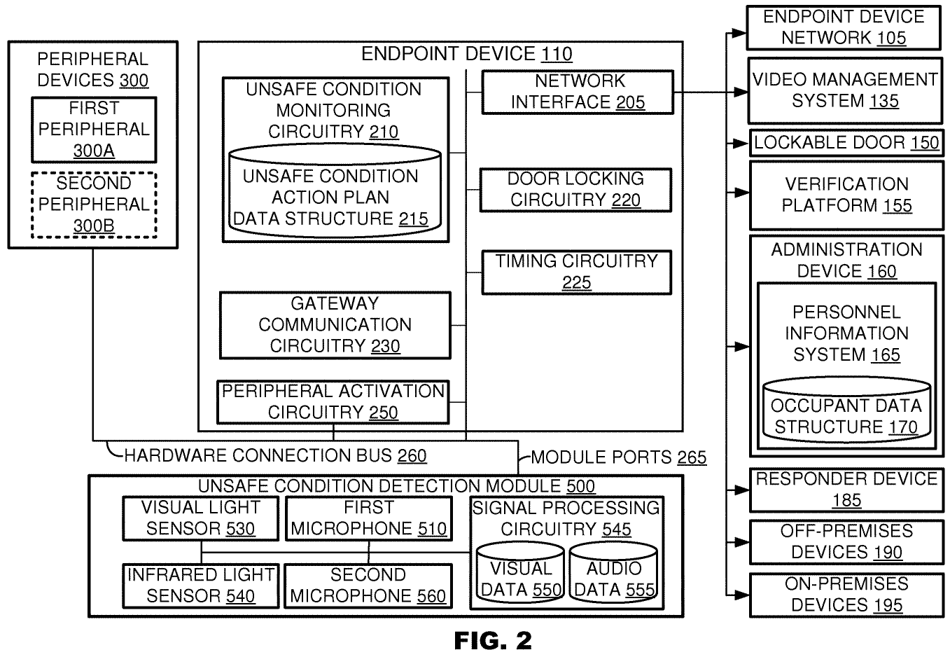

Although not illustrated in the example of FIG. 1, the administration device 160 includes door locking circuitry that provides similar functionality to the door locking circuitry 220 of FIG. 2 of the endpoint device 110 to lock at least one remotely lockable door 150 and a network interface that provides similar functionality to the network interface 205 of FIG. 2 of the endpoint device 110. For example, the network interface of the administration device 160 may receive a query from the network interface 205 of the endpoint device 110. The endpoint device 110 may attempt to retrieve information regarding a total quantity of occupants in the building with the query transmitted to the administration device 160. The administration device 160 accesses the personnel information system 165 and the associated occupant database 170 to transmit the quantity of occupants in the building to the endpoint device 110 and/or the responder device 185. The network interface of the administration device 160 may transmit the portion of the occupant information through at least a subset of a plurality of channels. The plurality of channels may include at least one of a text message channel, an email channel, a social media channel, a cellular phone call channel, an internet phone call channel, and a user application notification channel.

Furthermore, the network interface of the administration device 160 may use a location signal of the at least one external device to determine if the at least one external device is an on-premise external device 195 that is located within the building, or an off-premise external device 190 that is located outside of the building. Based on the determination if the external device is either an on-premise external device 195 or an off-premise external device 190, the example administration device 160 transmits a first data message to the on-premise external device 195 (e.g., “shelter-in-place”) and transmits a second data message to the off-premise external device 190 (e.g., “unsafe condition detected, please pick up your child after the situation is resolved”).

After an unsafe condition is detected, a responder 180 may drive a responder vehicle 175 to the building. In the example of FIG. 1, the responder device 185 is connected to the endpoint device network 105, the verification platform 155, and the administration device 160. In some examples, the responder device 185 is implemented as a law enforcement headset. The endpoint device 110 causes data from the occupant database 170 of the personnel information system 165 to be transmitted via the administration device 160 to the responder device 185. Additionally, the endpoint device 110 causes the wireless communication router 120 to establish the responder Wi-Fi network 125. Once in range of the building, the responder device 185 may connect to the responder Wi-Fi network 125 and access internal video data. In some examples, the endpoint device 110 directly transmits video data to the responder device 185. For example, the endpoint device 110 may use common data transmission techniques such as a cellular connection, a streaming connection, an internet connection, and other suitable connections to transmit video to the responder device 185.

The endpoint device network 105 and/or the administration device 160 may be connected to a plurality of external devices (e.g., smart phone, a wearable computing device, a tablet computer, a laptop computer, and a desktop computer and other such suitable electronic devices), which may be classified as off-premises devices 190 and on-premises devices 195. For example, in the context of a school, one implementation of the off-premises devices 190 may be a smartwatch that is accessible by a parent of a student and a second implementation of the off-premises devices 190 may be a smartphone that is accessible by a student that is absent from school. One example implementation of the on-premise device 195 in the context of a school may be a tablet that is accessible by a teacher, and the smartphone of a student that is present at school may be another on-premise device 195.

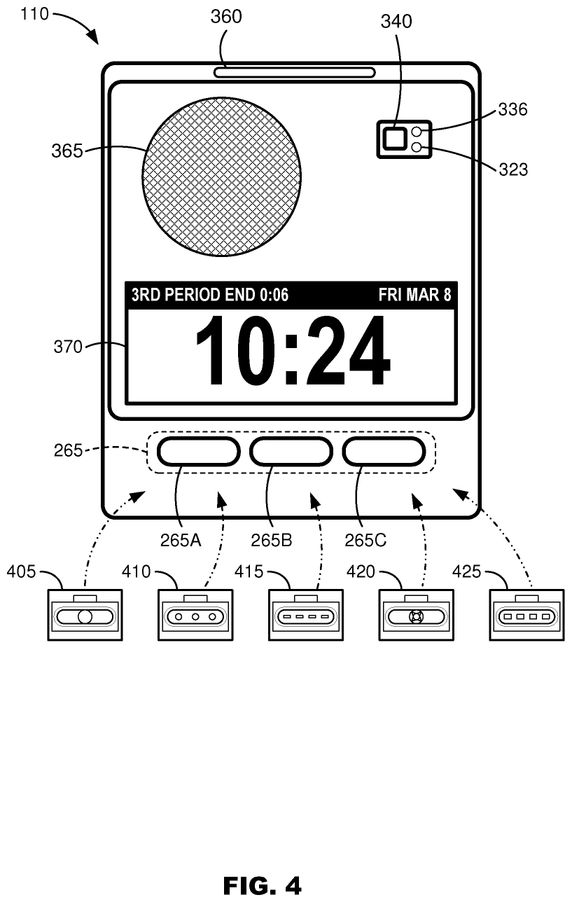

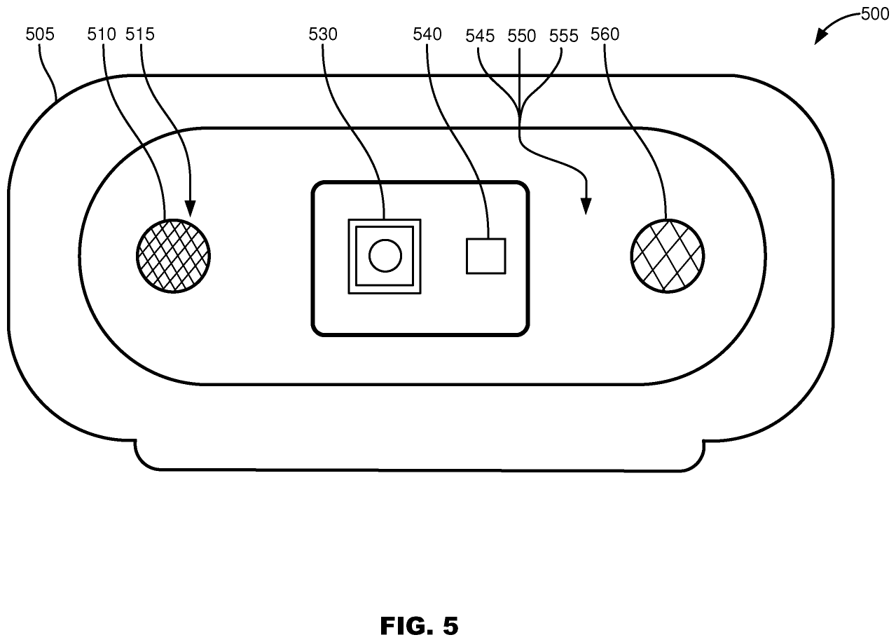

FIG. 2 is a block diagram of the endpoint device 110 of FIG. 1. The example endpoint device 110 includes a network interface 205, unsafe condition monitoring circuitry 210, an unsafe condition action plan data structure 215, door locking circuitry 220, timing circuitry 225, gateway communication circuitry 230, and peripheral activation circuitry 250. The endpoint device 110 includes a hardware connection bus 260 which allows connection of the endpoint device 110 to peripheral devices 300 which are described in connection with FIG. 3. Additionally, the hardware connection bus 260 includes a plurality of module ports 265 which allow connection of a plurality of modules to the endpoint device 110 as described in connection with FIG. 4. In the example of FIG. 2, the endpoint device 110 is connected to an example unsafe condition detection module 500. Referring also to FIG. 5, the example unsafe condition detection module 500 includes a visual light sensor 530, an infrared light sensor 540, a first microphone 510, a second microphone 560, and signal processing circuitry 545. The first microphone 510 and the second microphone 560 capture audio information and store the captured audio information in the audio data structure 555. Similarly, the visual light sensor 530 and the infrared light sensor 540 capture visual information and store the captured visual information in the visual data structure 550. In other examples, although not illustrated in the example of FIG. 2, the audio information and the visual information may be stored in a data structure that is local to the endpoint device 110. In such examples, the audio information and the visual information may be processed by a signal processor that is local to the endpoint device 110.

As shown in the example of FIG. 5, the unsafe condition detection module 500 further includes a housing 505 that positions the two microphones 510, 560 and the two light sensors 530, 540. The first microphone 510 may be positioned behind damping material 515, which changes the decibel range to detectable sounds of the first microphone 510. In the example of FIG. 5, the first microphone 510 with the damping material 515 captures sounds between seventy decibels and one-hundred and seventy decibels, while the second microphone 560 (which may not have any associated damping material 515) captures sounds between twenty decibels and one-hundred decibels. Therefore, the first microphone 510 and the damping material 515 may be referred to as a “loud-noise microphone” while the second microphone 560 may be referred to as a “human-speech microphone” based on the intended sound levels that the different microphones 510, 560 are designed to capture.

The first microphone 510, which is located on a first side of the housing 505 (e.g., the left side), is facing the same direction as the second microphone 560, which is located on a second side of the housing 505 (e.g., the right side). The light sensors 530, 540 are located between the first microphone 510 and the second microphone 560. In the example of FIG. 5, the visual light sensor 530 is located closer to the first microphone 510 and the infrared light sensor 540 is located closer to the second microphone 560. The example visual light sensor 530 is to capture visual light between three-hundred and fifty nanometers and one-thousand and one-hundred nanometers. The example infrared light sensor 540 is to capture infrared light between five-hundred and fifty nanometers and two-thousand and five-hundred nanometers.

The signal processing circuitry 545 of the unsafe condition detection module 500 uses the signals to determine whether an unsafe condition has occurred. For example, a gunshot typically produces a sound of at least one-hundred decibels and is accompanied by an infrared pulse. Therefore, based on the timing between the light pulse (e.g., “the flash”) and the sound (e.g., “the bang”), the signal processing circuitry 545 can determine the distance of the gunshot from the unsafe condition detection module 500. However, other unsafe conditions have different features. For example, a fire will emit both visual light and infrared light, but is unlikely to have a characteristic sound. For example, breaking glass or rushing water as associated with a flood may have characteristic sound, but do not have characteristic light spectrum value. In some examples, the signal processing circuitry 545 provides the signals of the unsafe condition detection module 500 for processing at the endpoint device 110. In such examples, the endpoint device 110 determines whether an unsafe condition has occurred.

Returning to the example of FIG. 2, the network interface 205 enables the endpoint device 110 to communicate via a Wi-Fi connection, a Bluetooth connection, an Ethernet connection, a cellular telephone system, or any other suitable connection with the other endpoint devices of the endpoint device network 105, the video management system 130, the lockable door 150, the verification platform 155, the personnel information system 165, the responder device 185, the off-premises devices 190, and the on-premises devices 195. The network interface 205 is to transmit an alert to the personnel information system 165. The alert is to instruct the personnel information system 165 to transmit occupant data to at least one external device such as the responder device 185, the off-premises devices 190, and/or the on-premises devices 195. In other words, the network interface 205 transmits an unsafe condition status to the personnel information system 165 based on detection of an unsafe condition.

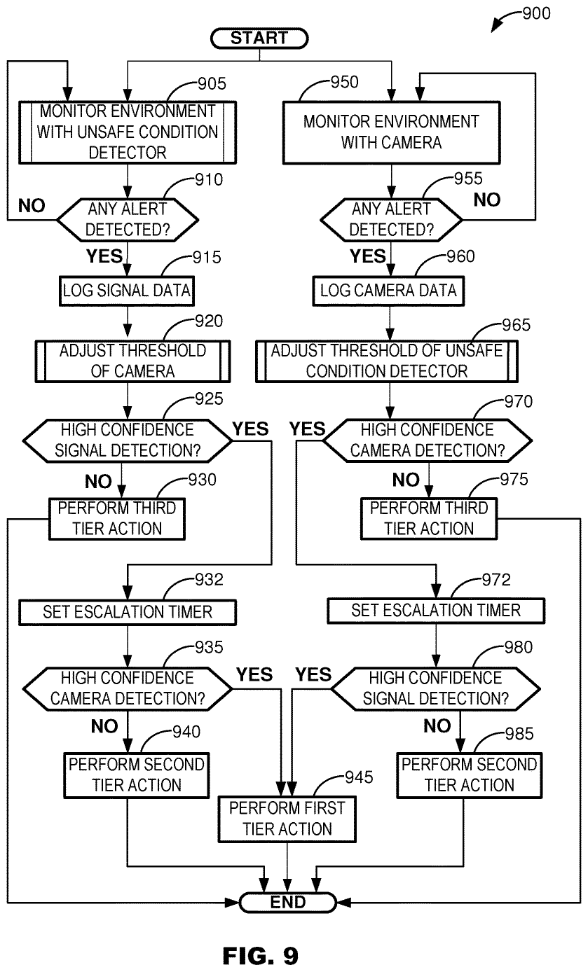

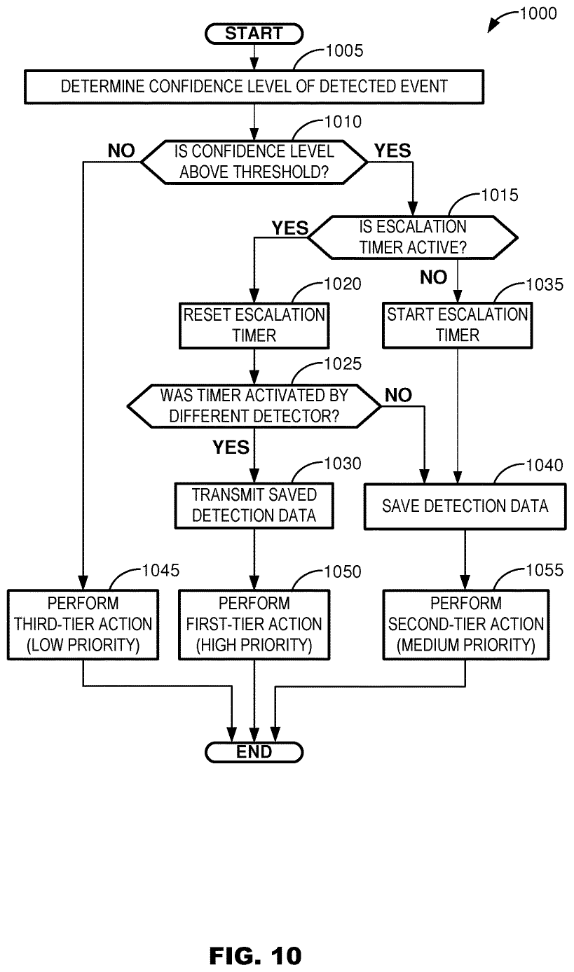

The unsafe condition monitoring circuitry 210 is to, based on sensor data, determine that an unsafe condition is present in the building. The unsafe condition monitoring circuitry 210 may determine an associated confidence level that an unsafe condition is present in the building (e.g., seventy percent, ninety percent, etc.). The confidence level may be based on whether there are multiple detections by different types of detectors within a time period as described in connection with FIGS. 9-10. Based on the confidence level, the unsafe condition monitoring circuitry 210 may cause the endpoint device 110 to perform different actions at different tier-levels. For example, a first-tier action (e.g., highest priority action, level one action, etc.) may be based on a high confidence alert that is triggered by multiple sources such as the unsafe condition detection module 500 and an AI-enhanced camera described in connection with FIG. 3. An example second-tier action may be based on a high confidence alert that is triggered by a single source such as only the unsafe condition detection module 500 or the AI-enhanced camera and a third-tier action may be based on a non-high confidence alert that is triggered by a single source.

Based on the tiers, the endpoint device 110 may perform different actions. For example, if there is a third-tier detection, the endpoint device 110, via the network interface 205, may transmit a message to internal security personnel. For example, if there is a second-tier action, the endpoint device 110 may perform the action associated with the third-tier detection and additionally perform another action such as transmitting, via the network interface 205, detection data (e.g., sensor data, audio data, light pulse data, camera images, etc.) to the verification platform 155. For example, if there is a first-tier action, the endpoint device 110 may perform the actions associated with both the third-tier and second tier detections, and additionally perform another action such as auto-dialing an emergency response number (e.g., “9-1-1”).

In addition to determining that an unsafe condition is present, the unsafe condition monitoring circuitry 210 may operate the unsafe condition action plan data structure 215 and retrieve an associated action plan based on the type of the unsafe condition. For example, if the unsafe condition is an armed intruder, the associated action plan may be to cause peripheral devices 300 (e.g., the flasher 360, the speaker 365, and the internal front display 370) to present a warning (e.g., a flashing light warning, an auditory warning, a textual warning) for building occupants to shelter in place and lock themselves in rooms. Alternatively, if the unsafe condition is a fire, the associated action plan may be to cause the peripheral devices 300 to present a warning for building occupants to evacuate the building.

The unsafe condition action plan data structure 215 stores the action plans for operating the endpoint device 110 and may be implemented as a database such as relational databases and NoSQL databases, a primitive data structure (e.g., integers, floats, characters, Boolean values, etc.), a linear non-primitive data structure (e.g., array, stack, queue, linked list etc.), a non-linear non-primitive data structure (e.g., tree, graph, hash table, binary tree, etc.), and formats such as .json, yml, or any plain text file format.

The example door locking circuitry 220 is cause locking of remotely lockable doors 150. After the unsafe condition is resolved, the door locking circuitry 220 may cause unlocking of remotely lockable doors 150 that are in the locked state.

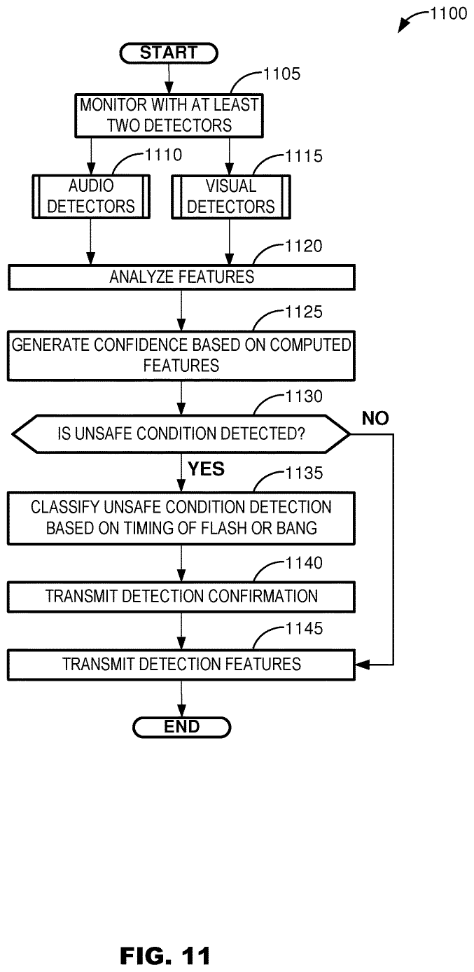

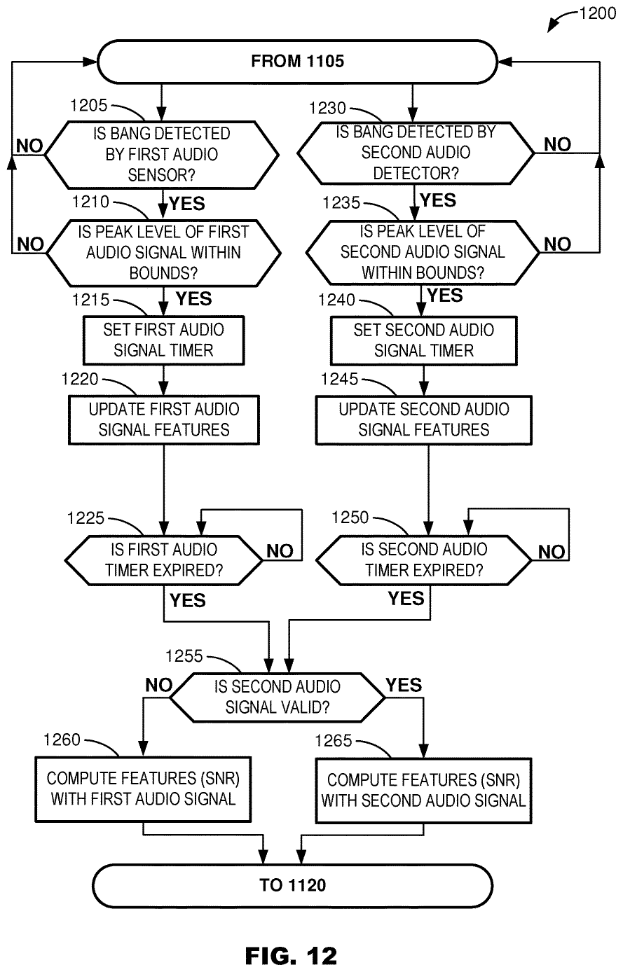

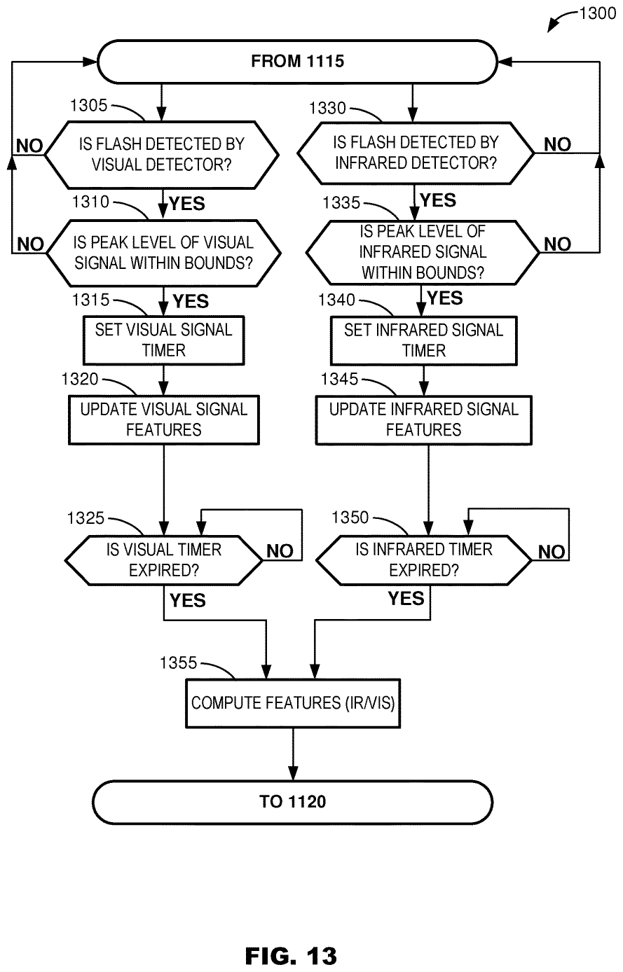

The timing circuitry 225 is to establish a plurality of timers. One example timer is for comparing the time between a light pulse and a sound wave which may be used to classify a distance of a gunshot from the endpoint device 110. A second timer is called a duration timer which determines the duration of the light pulse and the duration of the sound wave, which may be used to classify the caliber of a gunshot as described in connection with FIG. 11. Another timer is called an escalation timer and is used to define a window of time after a high-priority detection, where another high-priority detection of another type raises the priority level as described in connection with FIGS. 9-10. Another timer is a signal timer (e.g., audio signal timer, visual signal timer) which measure whether a detection from a first detection occurs near another detection as described in connection with FIGS. 12-13.

The gateway communication circuitry 230 is to command the wireless communication router 120 to establish a wireless network such as the responder Wi-Fi network 125 based on detection of an unsafe condition.

The peripheral activation circuitry 250 is to activate one of the peripheral devices 300 such as the first peripheral device 300A and/or the second peripheral device 300B. The peripheral devices 300 may be In other words, the peripheral activation circuitry 250 operates the peripheral devices 300. Turning to the example of FIG. 3, the peripheral devices 300 include visual sensors 310, audio sensors 330, environmental sensors 340, signal processing circuitry 350, artificial intelligence inference circuitry 355, and an example flasher 360, an example speaker 365, and an example internal front display 370.

The visual sensors 310 include cameras 315, light detectors 320, and an occupancy sensor 325. The cameras 315 include a visual-light video-camera 316, an infrared-light video-camera 317, a thermal camera 318, and a photography camera 319 configured to capture still images. The light detectors 320 include a visual-light detector 321 that is operable to detect light between three-hundred and fifty nanometers and one-thousand and one-hundred nanometers and an infrared-light detector 322 that is operable to detect light between five-hundred and fifty nanometers and two-thousand and five-hundred nanometers. The visual data captured by the light detectors 320 is stored in the visual data structure 351 of the signal processing circuitry 350. The image data captured by the cameras 315 is stored in the image data structure 356.

The audio sensors 330 include a plurality of microphones 335. The first microphone 336 (e.g., loud-noise microphone) may be structured similar to the first microphone 510 of the unsafe condition detection module 500 to capture sounds between seventy decibels and one-hundred and seventy decibels and the second microphone 337 (e.g., human-speech microphone) may be structured similar to the second microphone 560 of the unsafe condition detection module 500 to capture sounds between twenty decibels and one-hundred decibels. The audio data captured by the audio sensors 330 is stored in the audio data structure 352 of the signal processing circuitry 350.

The environmental sensors 340 include a temperature detector 341, a humidity detector 342, a particulate matter sensor 343, a smoke detector 344, and an atmospheric sensor 345. The environmental data captured by the environmental sensors 340 is stored in the environmental data structure 353 of the signal processing circuitry 350.

The signal processing circuitry 350 compares the various signals in the various data structures 351, 352, 353 and may determine that an unsafe condition is present similar to the signal processing circuitry 545. In some examples, where the endpoint device 110 is connected to an unsafe condition detection module 500, the unsafe condition detection module 500 provides the audio information obtained by either the first microphone 510 or the second microphone 560 and/or the visual information obtained by either the visual light sensor 530 or the infrared light sensor 540 for processing by the signal processing circuitry 350 of the peripheral devices or another signal processor that is local to the endpoint device 110.

The artificial intelligence inference circuitry 355 includes an image data structure 356 and an unsafe condition detection model 357. Based on image data which may be captured by one of the cameras 315, the unsafe condition detection model 357 (e.g., an object detection AI model such as YOLO, DETR, and FASTER-RCNN) determines whether an unsafe condition is present. Therefore, based on the functionality of the artificial intelligence inference circuitry 355 and one of the cameras 315, the peripheral devices 300 are able to operate as an AI-enhanced camera.

The flasher 360, the speaker 365, and the internal front display 370 output information.

FIG. 4 is a physical representation of one implementation of the endpoint device 110 of FIG. 1. In the illustrated implementation, the flasher 360 is located near the top of the endpoint device 110, the internal front display 370 is located near the middle of the endpoint device 110, and the speaker 365 is located between the flasher 360 and the internal front display 370. One of the environmental sensors 340 is located near the visual-light detector 321 and the second microphone 337. However, in other implementations, some of the peripheral devices 300 may be arranged differently or omitted entirely. For example, in a second implementation, the endpoint device 110 includes the speaker 365 and the second microphone 337. In an example third implementation, the endpoint device 110 includes the speaker 365, the second microphone 337, and adds the internal front display 370. In an example fourth implementation, the endpoint device 110 includes the components of the third implementation and further includes the flasher 360. In an example fifth implementation, the endpoint device 110 does not include the speaker 365, but does include the internal front display 370, the second microphone 337, and the flasher 360. In addition to the various peripheral devices 300 that may be included in the endpoint device 110, the endpoint device 110 may allow a consumer to install different modules that have specific features that the consumer desires. In the example of FIG. 4, the endpoint device 110 includes module ports 265 (e.g., a first module port 265A, a second module port 265B, and a third module port 265C) which are operable for connecting to an example first module 405 (e.g., gunshot detector module), an example second module 410 (e.g., video-camera, advanced environmental sensor etc.), an example third module 415 (e.g., occupancy sensor), an example fourth module 420 (e.g., flasher module), and an example fifth module 425 (e.g., infrared blaster). Additionally, one of the modules may be the unsafe condition detection module 500 as described earlier in connection with FIG. 5.

FIG. 6 illustrates a view on the responder device 185 after the responder device 185 connects to the responder Wi-Fi network 125. The user interface 600 displays a video dashboard. The video dashboard includes a live video section 605 and a cached video section 610. In other words, the user interface 600 allows presentation of real-time video and cached video.

In the example of FIG. 6, the unsafe condition (e.g., armed intruder, fire, flood, etc.) is represented by an “X” and is currently present in the science hallway. Therefore, the video management system 130 may present the live video feed corresponding to the science hallway higher than some of the other video feeds (e.g., the video feed corresponding to the physics classroom and the video feed corresponding to the history hallway, etc.). In some examples, the biology classroom and the chemistry classroom may be nearby the science hallway and therefore the video management system 130 may predict such locations as likely future destinations for an unsafe condition that is moving. Therefore, the live video feed corresponding to the biology classroom and the chemistry classroom is presented with a higher priority than the live video feed of the physics classroom and live video feed of the history hallway. In the example of FIG. 6, the cached video may also be arranged by priority. For example, the unsafe condition may have been present in the gymnasium earlier in the day, even though the unsafe condition is currently in the science hallway. Therefore, the cached data of the gymnasium and the science hallway is presented with a higher priority than the history hallway, the biology classroom, the chemistry classroom, and the physics classroom.

### Extended Operational Example

While the example components of the safety system 100 are described in FIGS. 1-6, the following description is an extended example which highlights key features of the safety system 100 in operation (e.g., in use) to improve safety in a building. An example first endpoint device 110A records video data of a suspect dressed in black and wearing tactical gear wandering near a school building with the example visual-light video-camera 316. In response to detection of the suspect, the first endpoint device 110A may process the data from the visual-light video-camera 316 with the unsafe condition detection model 357 and begin to calculate with the unsafe condition monitoring a degree of certainty that an unsafe condition exists based on, among other things, the fact that the suspect may be walking in an area where people are not expected to be at a particular time of day, and may be walking in the vicinity of locked doors. The first endpoint device 110A may communicate the calculated degree of certainty that an unsafe condition exists to the other endpoint devices 110B, 110C, 110D of the endpoint device network 105, the administration device 160, and/or the verification platform 155 via the network interface 205. If the suspect then walks to the back of the school, encounters a locked door, uses a gun to shoot the locked door, and subsequently enters the school building, the example second endpoint device 110B may capture the auditory sound associated with the gunshot via the example first microphone 336, and may further detect gunshot residue with the example particulate matter sensor 343. By combining the previously communicated certainty information derived from the visual-light video-camera 316 of the first endpoint device 110A, the first microphone 336, and the particulate matter sensor 343, and applying applicable weighting criteria via the unsafe condition monitoring circuitry 210, the second endpoint device 110B determines with a relatively high degree of certainty that an unsafe condition, specifically a school shooter situation, is present in the school.

After determining the unsafe condition is present, the unsafe condition monitoring circuitry 210 of the example second endpoint device 110B retrieves an action plan that corresponds to a school shooter situation from the unsafe condition action plan data structure 215. Due to the specific action plan, the peripheral activation circuitry 250 activates the speaker 365 to broadcast an auditory alarm (e.g., “Warning! Lockdown!”) which begins a lockdown. The second end-point device 110B transmits an alert to the other endpoint devices 110A, 110C, 110D in the building and the personnel information system 165. The first endpoint device 110A, the third endpoint device 110C, and the fourth endpoint device 110D may begin their own lockdown procedure. For example, if the third endpoint device 110C includes an internal front display 370, but does not include a speaker 365, the lockdown procedure of the third endpoint device 110C is to present a written message on the internal front display 370 which instructs occupants to hide in the nearest classroom with lockable doors 150. In addition to transmitting an alert, the second endpoint device 110B uses the gateway communication circuitry 230 to cause the wireless communication router 120 to generate the responder Wi-Fi network 125.

In this extended example, the school has five students named Alice, Bob, Charlie, Daniel, and Elizabeth and two teachers named Frank and George. On normal days, Alice, Bob, and Charlie are scheduled to be in Frank's classroom and Daniel and Elizabeth are scheduled to be in George's classroom.

The example administration device 160 accesses the personnel information system 165 which retrieves occupant data from the occupant database 170. The example administration device 160 transmits a portion of the occupant data which sets forth that Charlie is absent from school, that Alice and Bob are scheduled to be in Frank's classroom, and that Daniel and Elizabeth are scheduled to be in George's classroom. However, at the time of the lockdown, Daniel is walking in the hallway, and after hearing the auditory alarm, reacted by running into Frank's classroom. Additionally, Elizabeth was using the bathroom at the time of the lockdown and after hearing the auditory alarm, reacted by continuing to stay in the bathroom.

Based on the lockdown alert, the example personnel information system 165, through the network interface of the administration device 160, transmits a portion of the occupant data to a plurality of external devices such as the responder device 185 operated by Officer Harry, the off-premises devices 190 such as a mobile phone operated by Charlie, and the on-premises devices 195 such as a first tablet operated by teacher Frank, a second tablet operated by teacher George, and a smartwatch operated by Elizabeth.

Teacher George uses the example second tablet to transmit a data message to the example personnel information system 165 that both of his students are not in his classroom and are missing. Teacher Frank breathes a sigh of relief as he notices that Charlie is absent from school based on the occupant data transmitted to the example first tablet. Teacher Frank then uses the example first tablet to transmit a data message to the example personnel information system 165 that both of his expected students Alice and Bob (e.g., Charlie is not an expected student today because Charlie is absent from school) are safe in his classroom along with the extra student Daniel. Elizabeth uses her mobile phone to transmit a data message to the personnel information system 165 that she is scared and hiding in the bathroom.

The personnel information system 165 transmits that Elizabeth is still in danger to the responder device 185 operated by Officer Harry. After Officer Harry causes the responder device 185 to access the responder Wi-Fi network 125, Officer Harry receives a live video feed from the fourth endpoint device 110D which corresponds to the hallway that has the bathroom where Elizabeth is hiding. Officer Harry goes straight to the hallway after determining that the suspect is not in hallway via the live video feed from the example fourth endpoint device 110D. Officer Harry then rescues Elizabeth from the bathroom and moves her to a place of safety. Officer Harry then operates the responder device 185 to update the personnel information system 165, which updates the occupant database 170 that Elizabeth has been rescued and resumes the search for the suspect.

After a time period has elapsed (e.g., five minutes, ten minutes, an hour, etc.) the example responder device 185 updates the administration device 160 that the lockdown is current and the unsafe condition is still present by transmitting a lockdown status message to the administration device 160. The administration device 160 transmits a data message the endpoint device network 105 to continue performing the lockdown procedure. The administration device 160 transmits a data message to the off-premises devices 190 and the on-premises devices 195 that the lockdown is still active and to refrain from opening any doors.

After Officer Harry finds and then arrests the hooded man, the example endpoint devices 110 cease the auditory alarm and the personnel information system 165 transmits a data message that the unsafe condition is resolved to the example on-premises devices 195 operated by the teachers. Based on receiving the all-clear data message, teachers Frank and George open the doors of the locked classroom and resume teaching. The personnel information system 165 transmits the all-clear data message to the off-premises devices 190 which may be operated by parents of the students.

### Circuitry to Flowchart Correspondence

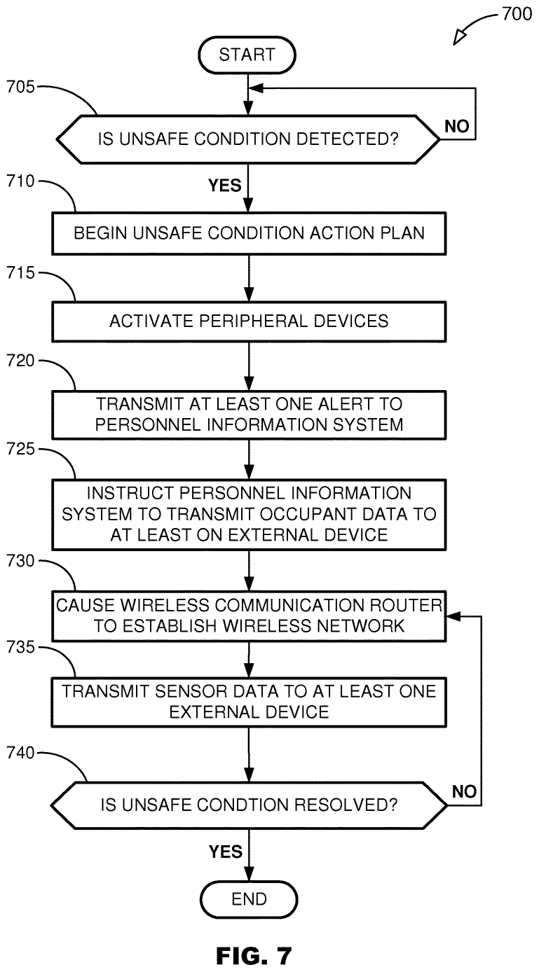

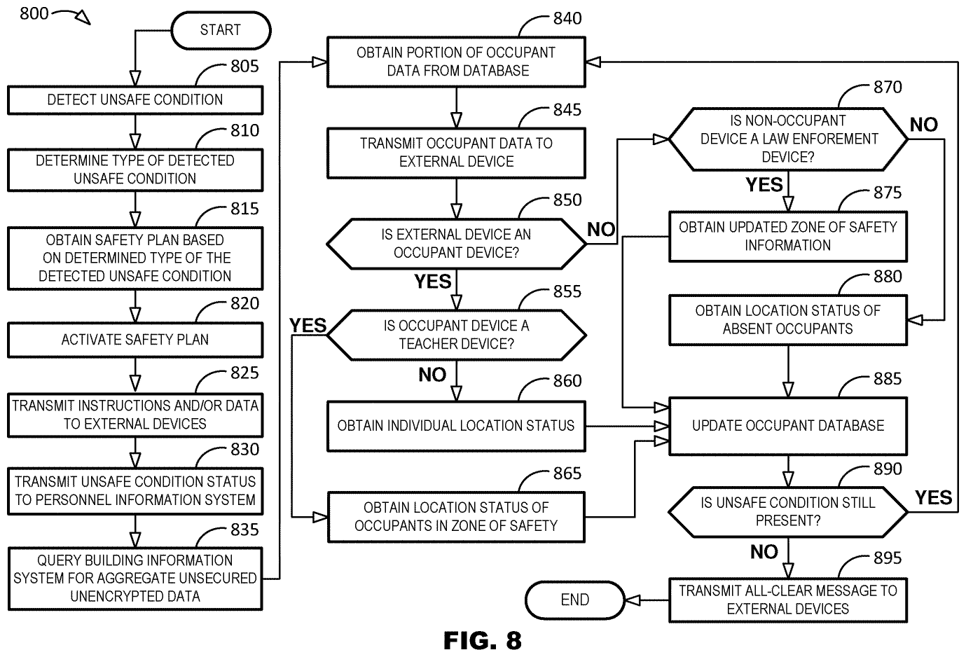

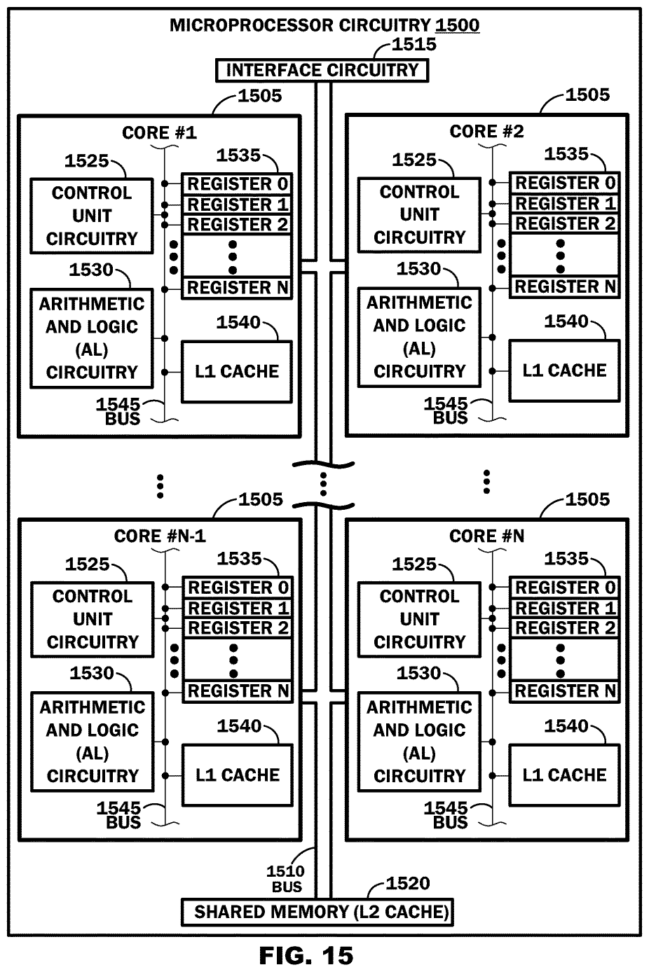

In some examples, the endpoint device 110 includes means for transmitting data. For example, the means for transmitting may be implemented by the network interface 205. In some examples, the network interface 205 is instantiated by programmable circuitry executing logic instructions and/or configured to perform operations such as those represented by the flowcharts of FIGS. 7, 8, 10. Specifically, the network interface 205 may be instantiated by the example microprocessor circuitry 1500 of FIG. 15 executing machine executable instructions such as those implemented by at least blocks 720, 735 of FIG. 7, blocks 825, 830, 895 of FIG. 8, and block 1030 of FIG. 10.

In some examples, the endpoint device 110 includes means for monitoring if an unsafe condition occurs. For example, the means for monitoring may be implemented by the unsafe condition monitoring circuitry 210. In some examples, the unsafe condition monitoring circuitry 210 is instantiated by programmable circuitry executing logic instructions and/or configured to perform operations such as those represented by the flowcharts of FIGS. 7, 8, 9, 10, 11. Specifically, the unsafe condition monitoring circuitry 210 may be instantiated by the example microprocessor circuitry 1500 of FIG. 15 executing machine executable instructions such as those implemented by at least blocks 705, 710, 740 of FIG. 7, blocks 805, 815, 820, 890 of FIG. 8, blocks 910, 915, 920, 925, 935, 945, 955, 960, 965, 970, 980 of FIG. 9, blocks 1005, 1010 of FIG. 10, and blocks 1105, 1110, and 1115 of FIG. 11.

In some examples, the endpoint device 110 includes means for measuring time. For example, the means for measuring time may be implemented by the timing circuitry 225. In some examples, the timing circuitry 225 is instantiated by programmable circuitry executing logic instructions and/or configured to perform operations such as those represented by the flowcharts of FIGS. 9, 10, 12, 13. Specifically, the timing circuitry 225 may be instantiated by the example microprocessor circuitry 1500 of FIG. 15 executing machine executable instructions such as those implemented by at least blocks 942, 987 of FIG. 9, blocks 1015, 1020, 1035 of FIG. 10, blocks 1215, 1225, 1240, 1250 of FIG. 12, and blocks 1310, 1325, 1340, 1350 of FIG. 13.

In some examples, the endpoint device 110 includes means for causing a router to establish a wireless network. For example, the means for causing a router to establish a wireless network may be implemented by the gateway communication circuitry 230. In some examples, the gateway communication circuitry 230 is instantiated by programmable circuitry executing logic instructions and/or configured to perform operations such as those represented by the flowchart of FIG. 7. Specifically, the gateway communication circuitry 230 may be instantiated by the example microprocessor circuitry 1500 of FIG. 15 executing machine executable instructions such as those implemented by at least blocks 730 of FIG. 7.

In some examples, the endpoint device 110 includes means for activating a peripheral. For example, the means for activating a peripheral may be implemented by the peripheral activation circuitry 250. In some examples, the peripheral activation circuitry 250 is instantiated by programmable circuitry executing logic instructions and/or configured to perform operations such as those represented by the flowcharts of FIGS. 7, 9, 10. Specifically, the peripheral activation circuitry 250 may be instantiated by the example microprocessor circuitry 1500 of FIG. 15 executing machine executable instructions such as those implemented by at least blocks 715 of FIG. 7, blocks 930, 940, 975 of FIG. 9, blocks 1040, 1045, 1050, 1055 of FIG. 10.

In some examples, the endpoint device 110 includes means for processing signals. For example, the means processing signals may be implemented by the signal processing circuitry 350 of the peripheral devices 300. In some examples, the signal processing circuitry 350 is instantiated by programmable circuitry executing logic instructions and/or configured to perform operations such as those represented by the flowcharts of FIGS. 9, 11, 12, 13. Specifically, the signal processing circuitry 350 may be instantiated by the example microprocessor circuitry 1500 of FIG. 15 executing machine executable instructions such as those implemented by at least blocks 905, 950, 985 of FIG. 9, blocks 1120, 1125, 1130, 1135, 1140, 1145 of FIG. 11, blocks 1205, 1210, 1220, 1230, 1235, 1245, 1255, 1260, 1265 of FIG. 12, and blocks 1305, 1310, 1320, 1330, 1335, 1345, 1355 of FIG. 13.

In some examples, the personnel information system 165 includes means for transmitting occupant data as described in connection with blocks 840, 845, 850, 855, 860, 865, 870, 875, 880, and 885 of FIG. 8.

Circuitry corresponding to the endpoint device 110 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the circuitry corresponding to the endpoint device 110 of FIG. 2 may be instantiated (e.g., creating an instance of, bring into being for any length of time, materialize, implement, etc.) by (1) an Application Specific Integrated Circuit (ASIC) and/or (2) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. In yet other examples, some or all of the circuitry of FIG. 2 may be implemented as a system-on-a-chip (SOC). Such example system-on-a-chip includes an integrated circuit that includes a central processing unit (CPU), memory, and peripherals onto a single chip.

### Circuitry Enablement and Flowchart Introduction

While an example manner of implementing the circuitry corresponding to the endpoint device 110 is illustrated in FIG. 2, one or more of the elements and/or processes illustrated in FIG. 2 may be combined, divided, re-arranged, omitted, eliminated, and/or implemented in any other way. Further, the example network interface 205, the example unsafe condition monitoring circuitry 210, the example door locking circuitry 220, the example timing circuitry 225, the example gateway communication circuitry 230, and the example peripheral activation circuitry 250.and/or, more generally, the example endpoint device 110 of FIG. 2, may be implemented by hardware alone or by hardware in combination with software and/or firmware. Thus, for example, any of the example network interface 205, the example unsafe condition monitoring circuitry 210, the example door locking circuitry 220, the example timing circuitry 225, the example gateway communication circuitry 230, and the example peripheral activation circuitry 250, and/or, more generally, the example endpoint device 110 of FIG. 2, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example endpoint device 110 of FIG. 2 may include one or more elements, processes, and/or devices in addition to, or instead of, those illustrated in FIG. 2, and/or may include more than one of any or all of the illustrated elements, processes and devices.

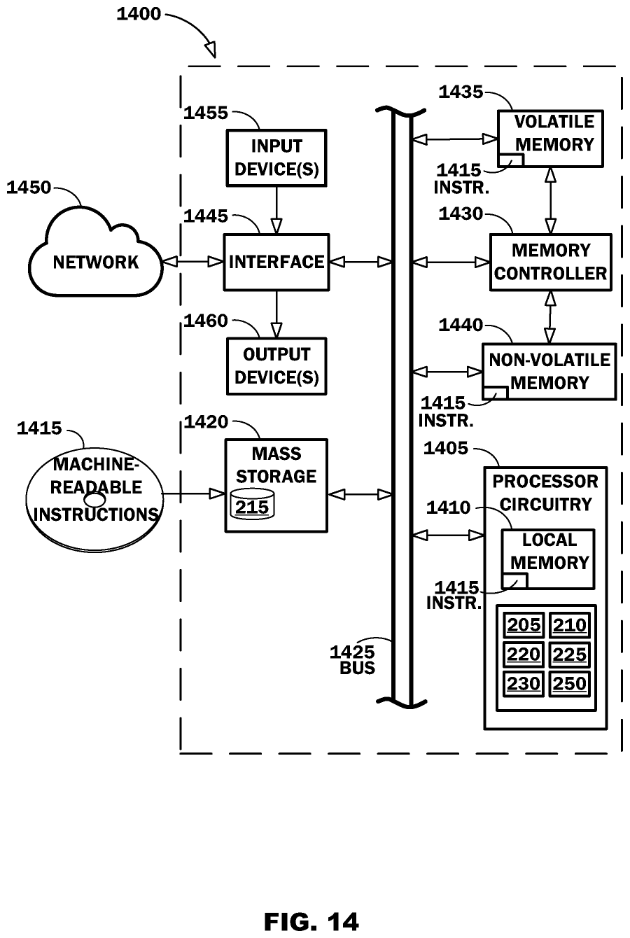

Flowchart representatives of example machine readable instructions, which may be executed by programmable circuitry to implement and/or instantiate the endpoint device 110 of FIG. 2 are shown in FIGS. 7-13. The machine readable instructions may be one or more executable programs or portion(s) of one or more executable programs for execution by programmable circuitry such as the programmable circuitry 1405 shown in the example programmable circuitry platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Synchronous Dynamic Random Access Memory (SDRAM), Dynamic Random Access Memory (DRAM), RAMBUS® Dynamic Random Access Memory (RDRAM®), and/or any other type of RAM device, Random Access Memory (RAM) of any type, etc.), and/or any other storage device or storage disk. Additionally, the example unsafe condition action plan data structure 215 may also be stored one or more non-transitory computer readable and/or machine readable storage mediums that are separate from the one or more non-transitory computer readable and/or machine readable storage mediums which store the program as embodied as instructions. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 7-13, many other methods of implementing the example endpoint device 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

As mentioned above, the example operations of FIGS. 7-13 may be implemented using executable instructions (e.g., computer readable and/or machine-readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

### Flowcharts

FIG. 7 is a flowchart representative of example machine-readable instructions 700 and/or example operations that may be executed, instantiated, and/or performed by example programmable circuitry to implement the example endpoint device 110 of the safety system 100 of FIG. 1 to transmit an unsafe condition status to the personnel information system 165. The example machine-readable instructions 700 and/or the example operations of FIG. 2 begin at block 705, at which the unsafe condition monitoring circuitry 210 determines if an unsafe condition is detected. For example, if the unsafe condition monitoring circuitry 210 determines that an unsafe condition is detected (e.g., “YES”), control advances to block 710. Alternatively, if the unsafe condition monitoring circuitry 210 determines that an unsafe condition is not detected (e.g., “NO”), control returns to block 705. The example unsafe condition monitoring circuitry 210 may determine that an unsafe condition is detected based on sensor data from at least one of the sensors such as the visual sensors 310, the audio sensors 330, the environmental sensors 340, an detection confirmation from the artificial intelligence inference circuitry 355, or the unsafe condition detection module 500. For example, the infrared-light detector 322 and the first microphone 336 might be used to determine that a gunshot was seen and heard in a first hallway in a building.

At block 710, the unsafe condition monitoring circuitry 210 is to begin the unsafe condition action plan. For example, the unsafe condition monitoring circuitry 210 may begin a lockdown procedure if the unsafe condition is an armed intruder or a tornado. Alternatively, the unsafe condition monitoring circuitry 210 may begin an evacuation procedure if the unsafe condition is a fire or a bomb. The unsafe condition monitoring circuitry 210 accesses the procedure as stored in the unsafe condition action plan data structure 215.

At block 715, the peripheral activation circuitry 250 is to activate at least one of the peripheral devices 300. For example, the peripheral activation circuitry 250 may cause the speaker 365 to sound an auditory alarm, the flasher 360 to output a strobe of light, and the internal front display 370 to present a text-based warning.

At block 720, the network interface 205 is to transmit at least one lockdown alert to the personnel information system 165. For example, the network interface 205 may transmit an un-safe condition status to the administration device 160 which has access to the personnel information system 165.

At block 725, the network interface 205 is to transmit an instruction to the personnel information system 165 to transmit occupant data to at least one external device. For example, the network interface 205 transmits an instruction to the network interface of the administration device 160 to transmit occupant data from the occupant database 170 to an external device such as the responder device 185, the off-premises devices 190, or the on-premises devices 195. The instruction is operable to cause the personnel information system 165 to use and/or transmit occupant data (e.g., secured information such as class schedules and room locations) to a plurality of users such as the example responder 180, parents, teachers, students who may be absent from school, and students who may be currently at school.

At block 730, the gateway communication circuitry 230 causes the wireless communication router to establish a wireless network. For example, the responder 180 may operate the responder device 185 to access video data at a faster data-speed due to the established wireless network.

At block 735, the network interface 205 is to transmit sensor data to at least one of the external devices. For example, the endpoint device 110 may directly transmit a live video feed from the visual-light video-camera 316 to the responder device 185. For example, the endpoint device 110 may stream the live video feed to the wireless network, which the responder device 185 may access.

At block 740, the example unsafe condition monitoring circuitry 210 determines if the unsafe condition is resolved. For example, if the unsafe condition monitoring circuitry 210 determines that the unsafe condition is resolved (e.g., “YES”), then the machine-readable instructions 700 end. Alternatively, if the example unsafe condition monitoring circuitry 210 determines that the unsafe condition is not resolved (e.g., “NO”), control returns to block 730. In some examples, the example unsafe condition monitoring circuitry 210 determines if the unsafe condition is resolved by waiting for receipt from an all-clear message from the responder device 185 operated by the responder 180 or the administration device 160. In other examples, the example unsafe condition monitoring circuitry 210 determines if the unsafe condition is resolved by determining if the unsafe condition is still detectable in any of the sensor data generated by the peripheral devices 300 or the unsafe condition detection module 500.

FIG. 8 is a flowchart representative of example machine-readable instructions 800 and/or example operations that may be executed, instantiated, and/or performed by example programmable circuitry to implement the safety system 100 of FIG. 1 to detect an unsafe condition and transmit occupant data to at least one of a plurality of external devices. The machine-readable instructions 800 and/or example operations begin at block 805, at which the example unsafe condition monitoring circuitry 210 to detects an unsafe condition. For example, the unsafe condition monitoring circuitry 210 of the endpoint device 110 may detect an unsafe condition based on obtaining a result from the signal processing circuitry 350 analyzing sensor data in the visual data structure 351, the audio data structure 352, or the environmental data structure 353, or a result of the unsafe condition detection module 500, or a result from the artificial intelligence inference circuitry 355.

At block 810, the example unsafe condition monitoring circuitry 210 is to determine a type of the detected unsafe condition. For example, the unsafe condition monitoring circuitry 210 may determine the type of the detected unsafe condition by classifying the unsafe condition to generate an unsafe condition classification. For example, there are different types of unsafe conditions such as an armed intruder with a gun, a fire, a tornado, a flood, a power outage, and other dangerous occurrences which threaten human life.

For example, the unsafe condition monitoring circuitry 210 may determine that a fire is detected based on an increased temperature detection and a smoke detection. For example, the unsafe condition monitoring circuitry 210 may determine that an armed shooter is present in the building based on a noise that is in a frequency range associated with gunshots and video data that depicts an unknown person on the premises of the building. In some examples, the unsafe condition monitoring circuitry 210 determines the unsafe condition by using at least two of a plurality of peripheral devices 300.

In some examples, the unsafe condition monitoring circuitry 210 uses a first one of at least two of the plurality of peripheral devices 300 to generate a first confidence score (e.g., the infrared-light video-camera 317 is 50% confident that an armed assailant is present in the building) and uses a second one of the at least two of the plurality of peripheral devices 300 to generate a second confidence score (e.g., the visual-light video-camera 316 is 75% confident that an armed assailant is present in the building). If the second confidence score is greater than the first confidence score, the example unsafe condition monitoring circuitry 210 uses the second confidence score to confirm a positive detection of the unsafe condition. In some examples, the un-safe condition monitoring circuitry 210 is to use a combination of the first confidence score and the second confidence score is to confirm a positive detection of the unsafe condition if both the first confidence score and the second confidence score taken alone would not confirm a positive detection. In some examples, the confidence score of the first peripheral device 300A may adjust the confidence threshold of the second peripheral device 300B. For example, if the second peripheral device 300B has a confidence threshold of ninety-percent to identify an unsafe condition and the first peripheral device 300A has a positive detection, the confident threshold of the second peripheral device 300B may decrease to a level of eighty-percent. Adjustment of the confidence intervals is further described in connection with FIG. 9. Additionally, rather than adjusting a confidence threshold of the second peripheral device 300B, the first peripheral device 300A may instead increase the confidence score of the second peripheral device 300B. For example, if the first peripheral device 300A has a positive detection, and the second peripheral device 300B has a confidence score of seventy-percent, the confidence score of the second peripheral device 300B may increase to eighty-percent.

At block 815, the unsafe condition monitoring circuitry 210 is to obtain a safety plan based on the determined type of the detected unsafe condition. For example, the unsafe condition monitoring circuitry 210 may obtain a safety plan based on the determined type of the detected unsafe condition by obtaining a corresponding unsafe condition action plan from the unsafe condition action plan data structure 215. For example, there may be a fire safety plan which corresponds to the determined type (e.g., determined classification) of “fire” for the unsafe condition

At block 820, the unsafe condition monitoring circuitry 210 is to activate the obtained safety plan. For example, the unsafe condition monitoring circuitry 210 may activate the obtained safety plan by causing the door locking circuitry 220 to lock the lockable door 150 and the network interface 205 to transmit instructions to the endpoint device network 105.

At block 825, the example network interface 205 is to transmit instructions and/or data to at least one external device. For example, the unsafe condition monitoring circuitry 210 causes the network interface 205 to send either data, instructions, and/or a combination of the data and instructions based on the target device. For example, if the target device is an off-premises device 190, the network interface 205 may transmit an instruction operable to cause the off-premise device to provide the location signal. For example, if the target device is a responder device 185, the network interface 205 may transmit video data.

At block 830, the network interface 205 is to transmit an unsafe condition status to the personnel information system 165.

At block 835, the network interface 205 is to query the occupant database 170 of the personnel information system 165 for aggregate unsecured unencrypted data. For example, the aggregate unsecured unencrypted data may include occupant data that relates to occupants of a building. The example occupant data includes information corresponding to a quantity of occupants in the building (e.g., four hundred people in the school), an identity of occupants in the building (e.g., students, staff, and teachers in the school), and an expected location of occupants in the building (e.g., students are expected to be in classrooms or the bathroom).

At block 840, the personnel information system 165 obtains a portion of occupant data from the occupant database 170. For example, the network interface of the administration device 160 may load the portion of occupant data from the occupant database 170 by accessing any unencrypted occupant data from the occupant data structure 170.

At block 845, the personnel information system 165 is to transmit occupant data to at least one of the plurality of external devices. For example, the example network interface of the administration device 160 may transmit occupant data to the off-premises devices 190, the on-premises devices 195, or the responder device 185. The personnel information system 165, through the network interface of the administration device 160, may transmit occupant data through at least a subset of a plurality of channels. The plurality of channels may include at least one of a text message channel, an email channel, a social media channel, a cellular phone call channel, an internet phone call channel, and a user application notification channel.

Block 845 includes functionality of transmitting a first data message if external device is an on-premise device 195 (e.g., an occupant external device, a device operable by at least one of a teacher or a student) and transmitting a second data message if the external device is an off-premise device 190 (e.g., a non-occupant external device, a device operable by a parent) or the responder device 185.

At block 850, the example network interface of the personnel information system 165 is to determine if the at least one external device is an occupant device. For example, if the network interface of the personnel information system 165 determines that the at least one external device is an occupant device (e.g., “YES”), control advances to block 855. Alternatively, if the example network interface of the personnel information system 165 determines that the external device is not an occupant device (e.g., “NO”), control advances to block 870. The example network interface of the personnel information system 165 may determine if a first device of the external devices is an occupant device by using a location signal of the first device of the external devices.

For example, if the location signal of the first device of the external devices does not correspond to a GPS location associated with the building, then the network interface determines that the first device of the external devices is not an occupant device as the likely user of the first device is not a current occupant of the building. For example, if the location signal of the first device of the external devices corresponds to a GPS location associated with the building, then the network interface determines that the first device of the external devices is an occupant device as the likely user of the first device is a current occupant of the building.

At block 855, the example network interface of the personnel information system 165 determines if the occupant device is a teacher device. For example, if the network interface of the personnel information system 165 determines that the occupant device is a teacher device (e.g., “YES”), control advances to block 865. Alternatively, if the network interface of the personnel information system 165 determines that the occupant device is not a teacher device (e.g., “NO”), control advances to block 860. The example network interface of the personnel information system 165 may determine if the occupant device is a teacher device by accessing a directory stored in the occupant database 170.

At block 860, the network interface of the personnel information system 165 obtains an individual location status from the student device. For example, the network interface of the personnel information system 165 may obtain an individual location status from the student device (e.g., the mobile phone) by requesting the user of the device (e.g., the student 126) to respond with a data message (e.g., “My name is Mark and I'm hiding in the bathroom”) or a location permission for that individual student device. Control advances to block 885.

At block 875, the network interface of the personnel information system 165 obtains a location status of occupants in a zone of safety. For example, the network interface of the personnel information system 165 may obtain a location status of occupants in a zone of safety from the teacher device by requesting the user of the device (e.g., the teacher 124 of FIG. 1) to respond with a data message (e.g., “I have six children safe in my classroom”) or a location permission for the teacher device. For example, the data message from the teacher device (e.g., the tablet) corresponds to a location status of occupants within a safety zone of the secured classroom. Control advances to block 334.

At block 870, the network interface of the personnel information system 165 determines if the non-occupant device is a law enforcement device. For example, if the network interface of the personnel information system 165 determines that the non-occupant device is a law enforcement device (e.g., “YES”), control advances to block 875. Alternatively, if the example network interface of the example personnel information system 165 determines that the non-occupant device is not a law enforcement device (e.g., “NO”), control advances to block 880. The example network interface of the personnel information system 165 may determine if the non-occupant device is a law enforcement device by accessing a directory stored in the occupant data structure 170 for a responder 180 or an online archive.

At block 875, the network interface of the personnel information system 165 obtains an updated zone of safety information. For example, the network interface of the personnel information system 165 may obtain an updated zone of safety information (e.g., building zone safety status) from the law enforcement device by requesting the user of the device (e.g., the responder 180 of FIG. 1) to respond with a data message (e.g., “We have cleared A-wing of the building. The unsafe condition is not present in A-wing.”). For example, the responder device 185 of FIG. 1 may respond with a law enforcement data message that A-wing is clear. Control advances to block 885.

At block 880, the network interface of the personnel information system 165 obtains a location status of absent occupants. For example, the network interface of the personnel information system 165 may obtain a location status of absent occupants by requesting the user of the device (e.g., the parent 128 of FIG. 1) to respond with a data message (e.g., “My daughter Kate is absent from school today at the dentist.”). For example, the parent device (e.g., the smart-watch) transmits the location status of an occupant absent from the building. In some examples, the parent device downloads a user device application that is operable to exchange the safety information with the at least one personnel information system 165 of FIG. 1. Control advances to block 885.

At block 855, the example network interface of the personnel information system 165 uses information obtained from at least one of block 860, block 865, block 875, and block 880 and updates the occupant database 170 of the personnel information system 165. For example, the network interface of the personnel information system 165 may update the occupant database 170 based on all the data messages received from the external devices (e.g., that a first student named Mark is hiding in the bathroom, that a first teacher has six students safe in a secured classroom, that a second student Kate is not in the building, and that the police officers have cleared A-wing and therefore all occupants in A-wing are safe).

At block 890, the example unsafe condition monitoring circuitry 210 determines if the unsafe condition is still present. For example, if the unsafe condition monitoring circuitry 210 determines that the unsafe condition is still present (e.g., “YES”), control returns to block 840. Alternatively, if the unsafe condition monitoring circuitry 210 determines that the unsafe condition is not still present (e.g., “NO”), control advances to block 895. The example unsafe condition monitoring circuitry 210 may determine if the unsafe condition is still present by using generated sensor data and/or wait to receive confirmation from the responder device 185 that the un-safe condition is resolved.

At block 895, after determination by the unsafe condition monitoring circuitry 210 that the unsafe condition is not still present, the example network interface 205 transmits an all-clear message to at least one of the external devices. For example, the network interface 205 of the endpoint device 110 may transmit an all-clear message to on-premises devices 195 (e.g., a tablet operable by the teacher, a cellular phone operable by a student), the responder device 185, and the off-premises devices 190 (e.g., the smartwatch operable by a parent of one of the students). For example, the network interface 205 may broadcast an all-clear message with the peripheral devices 300 (e.g., an auditory message heard over the speaker 365, a visual message seen on the internal front display 370, etc.). After block 895, the machine-readable instructions 800 end.

FIG. 9 is a flowchart representative of example machine-readable instructions 900 and/or example operations that may be executed, instantiated, and/or performed by example programmable circuitry to implement the safety system 100 of FIG. 1 to

The instructions 900 begin in parallel at block 905 and block 950. At block 905, the end-point device 110 monitors the environment for unsafe conditions. In some examples, the end-point device 110 is connected to the unsafe condition detection module 500. In some examples, the endpoint device 110 includes separate peripheral devices 300 such as the visual-light detector 321 and the infrared-light detector 322, the first microphone 336, and the second microphone 337, and uses signal processing circuitry 350 to monitor the environment. Block 905 is further described in connection with FIG. 11. After block 905, control advances to block 910.

At block 910, the unsafe condition detection module 500 and/or the signal processing circuitry 350 determines if an alert is detected. For example, if the unsafe condition detection module 500 and/or the signal processing circuitry 350 determines that an alert is detected (e.g., “YES”), control advances to block 915. Alternatively, if the unsafe condition detection module 500 and/or the signal processing circuitry 350 determines than an alert is not detected (e.g., “NO”), control returns to block 905.

At block 915, the unsafe condition monitoring circuitry 210 logs the signal data. For example, the unsafe condition monitoring circuitry 210 receives the alert from either a combination of the peripheral devices 300 or the unsafe condition detection module 500, and stores signals indicative of the unsafe condition.

At block 920, the unsafe condition monitoring circuitry 210 adjusts the threshold of the AI-enhanced camera. For example, if the unsafe condition detection model 357 has a positive detection threshold of at a first level (e.g., ninety-percent), due to the unsafe condition detection from the unsafe condition detection module 500 and/or the signal processing circuitry 350, the positive detection threshold may be reduced to a second level (e.g., sixty-percent).

At block 925, the unsafe condition monitoring circuitry 210 determines if there is a high confidence signal detection. For example, if the unsafe condition monitoring circuitry 210 determines that there is a high confidence signal detection (e.g., “YES”), control advances to block 935. Alternatively, if the unsafe condition monitoring circuitry 210 determines that there is not a high confidence signal detection (e.g., “NO”), control advances to block 930. The example un-safe condition monitoring circuitry 210 may determine if there is a high confidence signal detection based on the logged signal data of block 915.

At block 930, if there is a not a high-confidence signal detection, the endpoint device 110 performs a third-tier action. For example, the unsafe condition monitoring circuitry 210 may access the unsafe condition action plan data structure 215 and provide instructions to the associated circuitry components. For example, if the third-tier action is to transmit a message to internal security personnel, the unsafe condition monitoring circuitry 210 may cause the network interface 205 to send a text message to a security guard regarding the low-confidence signal detection. After block 930, the instructions 900 end.

At block 932, the timing circuitry 225 sets an escalation timer. For example, even though there is currently not a high-confidence camera detection of an unsafe condition (e.g., there is not an image of a gun being wielded by an armed intruder), because there was a high-confidence signal detection of an unsafe condition (e.g., based on the light pulse and the sound profile, there was likely a gunshot), an escalation timer is set which reduces the confidence required for the unsafe condition detection model 357 to detect an unsafe condition on image data. For example, if the unsafe condition detection model 357 typically requires a confidence threshold of ninety-percent to confirm if there is an unsafe condition, because of the escalation timer, the confidence threshold may be reduced to a lower value such as seventy-percent. After block 942, control advances to block 935.

At block 935, the unsafe condition monitoring circuitry 210 determines if there is a high confidence camera detection. For example, if the unsafe condition monitoring circuitry 210 determines that there is a high-confidence camera detection (e.g., “YES”), control advances to block 945. Alternatively, if the unsafe condition monitoring circuitry 210 determines that there is not a high-confidence camera detection (e.g., “NO”), control advances to block 940. For example, the unsafe condition monitoring circuitry 210 determines if the unsafe condition detection model 357 as executed by the artificial intelligence inference circuitry 355 on image data captured by at least one of the cameras 315 has determined that there is an unsafe condition. In other words, block 935 corresponds to the “YES” result of block 970.

At block 940, where there is not a high-confidence camera detection but there is a high-confidence signal detection, the endpoint device 110 performs a second-tier action. For example, if the second-tier action may be to transmit an image which corresponds to the unsafe condition to the verification platform 155, the unsafe condition monitoring circuitry 210 causes the network interface 205 to transmit the image. After block 940, the instructions 900 end.

At block 945, where there is a high-confidence camera detection and also a high-confidence signal detection, the endpoint device 110 performs a first-tier action. For example, based on the type of the unsafe condition, the first-tier action may be to lockdown the building or evacuate the building. The unsafe condition monitoring circuitry 210 may cause the door locking circuitry 220 to lock the lockable doors 150, the gateway communication circuitry 230 to generate a Wi-Fi network that is accessible by the responder device 185, and cause the peripheral activation circuitry 250 to cause the flasher 360 to flash lights, the speaker 365 to present audio content (e.g., a voice that says “LOCKDOWN! SHELTER IN PLACE!” that may be heard by a building occupant), and the internal front display 370 to present visual content (e.g., the word “LOCK-DOWN” scrolls across and may be read by a building occupant). After block 945, the instructions 900 end.

At block 950, the endpoint device 110 monitors the environment with an AI-enhanced camera. For example, the peripheral devices 300 may include a plurality of cameras 315 such as a visual-light video-camera 316, an infrared-light video-camera 317, a thermal camera 318, and a photography camera 319. Such cameras 315 may store images and video data in the image data structure 356. The artificial intelligence inference circuitry 355 runs an unsafe condition detection model 357 on the images and video-data stored in the image data structure 356.

At block 955, the unsafe condition monitoring circuitry 210 determines if there is an alert detected with the AI-enhanced camera. For example, if the unsafe condition monitoring circuitry 210 determines that an alert is detected (e.g., “YES”), control advances to block 960. Alternatively, if the unsafe condition monitoring circuitry 210 determines that there is not an alert detected (e.g., “NO”), control returns to block 950.

At block 960, the unsafe condition monitoring circuitry 210 logs the camera data that corresponds to the alert.

At block 965, the unsafe condition monitoring circuitry 210 adjusts the threshold of the unsafe condition detector (e.g., the unsafe condition detection module 500, the separate peripheral devices 300 such as the visual-light detector 321 and the infrared-light detector 322, the first microphone 336, and the second microphone 337, and signal processing circuitry 350 that when combined have a similar functionality as the unsafe condition detection module 500). For example, if the unsafe condition detector typically has a confidence threshold of eighty-percent, due to the alert of the AI-enhanced camera, the confidence threshold of the unsafe condition detector may decrease to seventy-percent.

At block 970, the unsafe condition monitoring circuitry 210 determines if there is a high confidence camera detection. For example, if the unsafe condition monitoring circuitry 210 determines that there is a high confidence camera detection (e.g., “YES”), control advances to block 972. Alternatively, if the unsafe condition monitoring circuitry 210 determines that there is not a high confidence camera detection (e.g., “NO”), control advances to block 975. The example unsafe condition monitoring circuitry 210 may determine if there is a high confidence camera detection based on the logged camera data of block 960.

At block 972, the timing circuitry 225 sets an escalation timer similar to block 932. After block 972, control advances to block 980.

At block 975, the endpoint device 110 performs a third-tier action such as the third-tier action described in connection with block 930. After block 975, the instructions 900 end.

At block 980, the unsafe condition monitoring circuitry 210 determines if there is a high confidence signal detection. For example, if the unsafe condition monitoring circuitry 210 determines that there is a high-confidence signal detection (e.g., “YES”), control advances to block 945, where the endpoint device 110 performs a first-tier action. Alternatively, if the unsafe condition monitoring circuitry 210 determines that there is not a high-confidence signal detection (e.g., “NO”), control advances to block 985, where the endpoint device 110 performs a second-tier action such as the second-tier action described in connection with block 940. Block 980 corresponds to the “YES” result of block 925. After block 985, the instructions 900 end.

FIG. 10 is a flowchart representative of example machine-readable instructions 1000 and/or example operations that may be executed, instantiated, and/or performed by example programmable circuitry to implement the endpoint device 110 of FIG. 1 to determine an appropriate priority level based on co-occurring detections. The instructions 1000 begin at block 1005, at which the unsafe condition monitoring circuitry 210 determines a confidence level of the detected event (e.g., ninety-percent confident, eighty-percent confident, etc.).

At block 1010, the unsafe condition monitoring circuitry 210 determines if the confidence level of the detected event is above a threshold. For example, if the unsafe condition monitoring circuitry 210 determines that the detected event is above a threshold (e.g., “YES”), control advances to block 1015. Alternatively, if the unsafe condition monitoring circuitry 210 determines that the detected event is not above the threshold (e.g., “NO”), control advances to block 1045. The example unsafe condition monitoring circuitry 210 may determine if the detected event is above the threshold based on comparing the confidence level (e.g., ninety percent) with the threshold (e.g., eighty-five percent).

At block 1015, the timing circuitry 225 determines if the escalation timer is active. For example, if the escalation timer is active (e.g., “YES”), control advances to block 1020. Alternatively, if the escalation timer is not active (e.g., “NO”), control advances to block 1035. For example, the escalation timer may be active if there is a recent detection which triggered the escalation timer.

At block 1020, where the escalation timer is currently active, the timing circuitry 225 re-sets the escalation timer. For example, the escalation timer may be run for five minutes before expiring.

At block 1025, the timing circuitry 225 determines if the escalation timer was activated by a different detector. For example, if the timing circuitry 225 determines that an earlier detection from the unsafe condition detection module 500 activated the escalation timer and there is a current detection from the AI-enhanced camera, the timing circuitry 225 determines that the escalation timer was activated by a different detector (e.g., “YES”). Alternatively, if the timing circuitry 225 determines that an earlier detection from the unsafe condition detection module 500 activated the escalation timer and there is a current detection from the unsafe condition detection module 500, the timing circuitry 225 determines that the escalation timer was not activated by a different detector (e.g., “NO”).

At block 1030, the network interface 205 transmits saved detection data. For example, if the escalation timer is not active or the escalation timer is activated a second time by the same source, then the detection data corresponding to the source is saved. For example, if the source is the unsafe condition detection module 500, the detection data may be an infrared light pulse indicative of a gunshot. This infrared light pulse may be stored visual data structure 550 by the signal processing circuitry 545. At block 1030, where a second source has activated the escalation timer, the detection data corresponding to the first source is transmitted (e.g., the infrared light pulse is sent to the verification platform 155). After block 1030, control advances to block 1040, where the endpoint device 110 performs a first tier action. For example, the endpoint device 110 may perform the first-tier action as described in connection with block 945 of FIG. 9. After block 1030, the instructions 1000 end.

At block 1035, where the escalation timer is currently not active, the timing circuitry 225 starts the escalation timer. After block 1035, control advances to block 1040.

At block 1040, the endpoint device 110 saves the detection data. The endpoint device 110 saves the detection data for the duration of the escalation timer and if there is a detection by another source, such as in connection with block 1030, the saved detection data may be transmitted. Alternatively, if the escalation timer expires, then the saved detection data may be removed. In other words, the endpoint device 110 uses the escalation timer to prevent unrelated detections from being combined, while allowing detections (e.g., the sound pulse, the light pulse) that are likely related to be transmitted outside the endpoint device 110 (e.g., to the second endpoint device 110B, to the verification platform 155, to the administration device 160, to the responder device 185, etc.). In some examples, where the unsafe condition is detected by the unsafe condition detection module 500, the signal processing circuitry 545 stores the detection data. In other examples, where the AI-enhanced camera detects the unsafe condition, the artificial intelligence inference circuitry 355 stores the detection data. In yet other examples, where the audio sensors 330 of the peripheral devices 300 detect the unsafe condition, the signal processing circuitry 350 stores the detection data. If there is a detection by another source, the stored detection data may be transmitted. After block 1040, control advances to block 1055.

At block 1055, the endpoint device 110 performs a second-tier action. For example, the endpoint device 110 may perform the second-tier action as described in connection with block 940 and/or block 985 of FIG. 9. After block 1055, the instructions 1000 end.

At block 1045, where the confidence level is not above the threshold, the endpoint device 110 performs a third-tier action. For example, the endpoint device 110 may perform the third-tier action as described in connection with block 930 and/or block 975 of FIG. 9. After block 1045, the instructions 1000 end.

FIG. 11 is a flowchart representative of example machine-readable instructions 1100 and/or example operations that may be executed, instantiated, and/or performed by example programmable circuitry to implement the endpoint device 110 of FIG. 1 to monitor the environment with an unsafe condition detector. The endpoint device 110 may use a connected module such as the unsafe condition detection module 500 and/or associated peripheral devices 300 to perform the operations of FIG. 11. The instructions 1100 of FIG. 11 correspond to block 905 of FIG. 9.

At block 1105, the endpoint device 110 monitors with at least two detectors. For example, the unsafe condition monitoring circuitry 210 may monitor the environment with two light detectors 320, two audio sensors 330, one of the light detectors 320 and one of the audio sensors 330, or with the unsafe condition detection module 500 which includes a visual light sensor 530, an infrared light sensor 540, a first microphone 510, and a second microphone 560. After block 1105, control advances to block 1110 and block 1115 in parallel.

At block 1110, the unsafe condition monitoring circuitry 210 monitors the environment with audio detectors. Block 1110 is further described in connection with FIG. 12. After block 1110, control advances to block 1120.

At block 1115, the unsafe condition monitoring circuitry 210 monitors the environment with visual detectors. Block 1115 is further described in connection with FIG. 13. After block 1115, control advances to block 1120.

At block 1120, the endpoint device 110 analyzes the detected features. For example, the signal processing circuitry 545 of the unsafe condition detection module 500 analyzes the features detected by the unsafe condition detection module 500. For example, the signal processing circuitry 350 of the peripheral devices 300 analyzes the features detected by the two light detectors 320, the two audio sensors 330, or the combination of one of the light detectors 320 and one of the audio sensors 330. For ease of convenience, for the remainder of FIG. 11, when either the signal processing circuitry 545 of the unsafe condition detection module 500 or the signal processing circuitry 350 of the peripheral devices 300 may perform substantially the same function, the phrase “respective signal processing circuitry 350, 545” is used.

At block 1125, the respective signal processing circuitry 350, 545 generates a confidence based on the analyzed features. For example, the respective signal processing circuitry 350, 545 may determine that there is a first confidence level for features detected by the audio detectors of block 1110 (e.g., seventy percent) and a second confidence level for features detected by the visual detectors of block 1115 (e.g., ninety percent).

At block 1130, the respective signal processing circuitry 350, 545, determines if an un-safe condition is detected. For example, if the respective signal processing circuitry 350, 545 determines that an unsafe condition is detected (e.g., “YES”), control advances to block 1135. Alternatively, if the respective signal processing circuitry 350, 545 determines that an unsafe condition is not detected (e.g., “NO”), control advances to block 1145. The respective signal processing circuitry 350, 545 may determine if an unsafe condition is detected based on a comparison with the confidence threshold.

At block 1135, the respective signal processing circuitry 350, 545 classifies the unsafe condition detection based on the timing of the flash or the bang. For example, if the elapsed time of the flash or the elapsed time of the bang is less than one millisecond, the respective signal processing circuitry 350, 545 classifies the overall unsafe condition detection as a firework. How-ever, if the duration of either the flash or the bang is between one millisecond and three milliseconds, the respective signal processing circuitry 350, 545 classifies the overall unsafe condition detection as a hand-gun. The example respective signal processing circuitry 350, 545 classifies elapsed times that are between three milliseconds and five milliseconds as a long-gun, and elapsed times that are greater than five milliseconds as an explosion. Based on the classification of the unsafe condition, the unsafe condition monitoring circuitry 210 may retrieve a specific action plan from the unsafe condition action plan data structure 215. Additionally, the respective signal processing circuitry 350, 545 may compare the timing between the flash and the bang to determine a respective distance and/or location of the gunshot. After block 1135, control advances to block 1140.

At block 1140, the respective signal processing circuitry 350, 545 transmits the detection confirmation to the unsafe condition monitoring circuitry 210. In other words, the respective signal processing circuitry 350, 545 provides an indication that an unsafe condition was detected to the unsafe condition monitoring circuitry 210.

At block 1145, the respective signal processing circuitry 350, 545 transmits the detection features to the unsafe condition monitoring circuitry 210. The unsafe condition monitoring circuitry 210 may provide the features that resulted in the unsafe condition detection to the verification platform 155 via the network interface 205. After block 1145, the instructions 1100 end.

FIG. 12 is a flowchart representative of example machine-readable instructions 1200 and/or example operations that may be executed, instantiated, and/or performed by example programmable circuitry to implement the endpoint device 110 of FIG. 1 to monitor the environment with at least two audio sensors 330. The endpoint device 110 may use a connected module such as the unsafe condition detection module 500 which includes the first microphone 510 and the second microphone 560 and/or the first microphone 336 and the second microphone 337 to perform the operations of FIG. 12. The instructions 1200 of FIG. 12 correspond to block 1110 of FIG. 11. The instructions 1200 begin in parallel with block 1205 and block 1230. At block 1205, the

At block 1205, the signal processing circuitry 350, 545 determines if a bang is detected by the first audio sensor which may be the second microphone 337 (e.g., human-speech microphone) of the peripheral devices or the second microphone 560 of the unsafe condition detection module 500.

At block 1210, the signal processing circuitry 350, 545 determines if the peak level of the first audio signal is within bounds (e.g., at an appropriate decibel level indicative of a gunshot). If the signal processing circuitry 350, 545 determines that the peak level of the first audio signal is within bounds (e.g., “YES”), control advances to block 1215. Alternatively, if the signal processing circuitry 350, 545 determines that the peak level of the first audio signal is not within bounds (e.g., “NO”), control returns to block 1105 of FIG. 11.

At block 1215, the timing circuitry 225 sets the first audio signal timer.

At block 1220, the signal processing circuitry 350, 545 updates the first audio signal features while the first audio signal timer is active. For example, the peak level may increase or decrease while the first audio signal timer is active.

At block 1225, the timing circuitry 225 determines if the first audio signal timer is expired. For example, if the timing circuitry 225 determines that the first audio signal timer has expired (e.g., “YES”), control advances to block 1255. Alternatively, if the timing circuitry 225 determines that the second audio signal timer has not expired (e.g., “NO”), control returns to block 1225.

At block 1230, the signal processing circuitry 350, 545 determines if the bang is detected by the second audio detector which may be the first microphone 336 (e.g., loud-noise microphone) of the peripheral devices or the first microphone 510 of the unsafe condition detection module 500.

At block 1235, the signal processing circuitry 350, 545 determines whether the peak level of the second audio signal is within bounds. For example, if the signal processing circuitry 350, 545 determines that the second audio signal is within bounds (e.g., “YES”), control advances to block 1240. Alternatively, if the signal processing circuitry 350, 545 determines that the second audio signal is not within bounds (e.g., “NO”), control returns to block 1105 of FIG. 11.

At block 1240, the timing circuitry 225 sets a second audio signal timer.

At block 1245, the signal processing circuitry 350, 545 updates the second audio signal features while the timer is active.

At block 1250, the timing circuitry 225 determines whether the second audio signal timer is expired. For example, if the timing circuitry 225 determines that the second audio signal timer has expired (e.g., “YES”), control advances to block 1255. Alternatively, if the timing circuitry 225 determines that the second audio signal timer has not expired (e.g., “NO”), control returns to block 1250.

At block 1255, the signal processing circuitry 350, 545 determines whether the second audio signal is valid. For example, if the peak level of the second audio signal (e.g., the loud-noise microphone) is within the bounds and valid, then the signal processing circuitry 350, 545 computes the features (e.g., signal-to-noise ratio) with the second audio signal. Alternatively, if the peak level of the second audio signal is not valid, then the features are computed with the first audio signal.

At block 1260, the signal processing circuitry 350, 545 computes the features with the first audio signal that corresponds to the second microphone 337 (e.g., human-speech microphone) of the peripheral devices or the second microphone 560 of the unsafe condition detection module 500.

At block 1265, the signal processing circuitry 350, 545 computes the features with the second audio signal that corresponds to the first microphone 336 (e.g., loud-noise microphone) of the peripheral devices or the first microphone 510 of the unsafe condition detection module 500.

After block 1260 and block 1265, control returns to block 1120 of FIG. 11.

FIG. 13 is a flowchart representative of example machine-readable instructions 1300 and/or example operations that may be executed, instantiated, and/or performed by example programmable circuitry to implement the endpoint device 110 of FIG. 1 to monitor the environment with at least two light detectors 320. The endpoint device 110 may use a connected module such as the unsafe condition detection module 500 which includes the visual light sensor 530 and the infrared light sensor 540 and/or the visual-light detector 321 and the infrared-light detector 322 to perform the operations of FIG. 13. The instructions 1300 of FIG. 13 correspond to block 1115 of FIG. 11. The instructions 1300 begin in parallel with block 1305 and block 1330.

At block 1305, the signal processing circuitry 350, 545 determines if a flash is detected by the visual-light detector 321 or the visual light sensor 530. For example, if the signal processing circuitry 350, 545 determines that a flash is detected (e.g., “YES”), control advances to block 1310. Alternatively, if the signal processing circuitry 350, 545 determines that a flash is not detected (e.g., “NO”), control returns to block 1115 of FIG. 11.

At block 1310, the signal processing circuitry 350, 545 determines if the peak level of the visual signal is within bounds (e.g., at an appropriate light level indicative of a gunshot). For example, if the signal processing circuitry 350, 545 determines that the peak level of the visual signal is within bounds (e.g., “YES”), control advances to block 1315. Alternatively, if the signal processing circuitry 350, 545 determines that the peak level of the visual signal is not within bounds (e.g., “NO”), control returns to block 1115 of FIG. 11.

At block 1315, the timing circuitry 225 sets the visual signal timer.

At block 1320, the signal processing circuitry 350, 545 updates the visual signal features while the visual signal timer is active.

At block 1325, the timing circuitry 225 determines if the visual signal timer is expired. For example, if the timing circuitry 225 determines that the visual signal timer is expired (e.g., “YES”), control advances to block 1355. Alternatively, if the timing circuitry 255 determines that the visual signal timer has not expired (e.g., “NO”), control returns to block 1325.

At block 1330, the signal processing circuitry 350, 545 determines if the flash is detected by the infrared-light detector 322 or the infrared light sensor 540. For example, if the signal processing circuitry 350, 545 determines that a flash is detected (e.g., “YES”), control advances to block 1335. Alternatively, if the signal processing circuitry 350, 545 determines that a flash is not detected (e.g., “NO”), control returns to block 1115 of FIG. 11.

At block 1335, the signal processing circuitry 350, 545 determines whether the peak level of the infrared signal is within bounds (e.g., at an appropriate light level indicative of a gunshot). For example, if the signal processing circuitry 350, 545 determines that the peak level of the infrared signal is within bounds (e.g., “YES”), control advances to block 1340. Alternatively, if the signal processing circuitry 350, 545 determines that the peak level of the visual signal is not within bounds (e.g., “NO”), control returns to block 1115 of FIG. 11.

At block 1340, the timing circuitry 225 sets an infrared signal timer.

At block 1345, the signal processing circuitry 350, 545 updates the infrared signal features while the timer is active.

At block 1350, the timing circuitry 225 determines whether infrared signal timer is expired. For example, if the timing circuitry 225 determines that the infrared signal timer is expired (e.g., “YES”), control advances to block 1355. Alternatively, if the timing circuitry 255 determines that the infrared signal timer has not expired (e.g., “NO”), control returns to block 1350.

At block 1355, the signal processing circuitry 350, 545 computes the features with the visual signal and the infrared signal. For example, the signal processing circuitry 350, 545 may compute a ratio that divides the infrared signal by the visual signal. After block 1335, control returns to block 1120 of FIG. 11.

### Hardware Enablement

FIG. 14 is a block diagram of an example programmable circuitry platform 1400 structured to execute and/or instantiate both the example machine-readable instructions and/or the example operations of FIGS. 7-13 to implement the endpoint device 110 of FIG. 2. The programmable circuitry platform 1400 can be, for example, a server, a personal computer, a workstation, a self-learning machine (e.g., a neural network), or any other type of computing and/or electronic device.

The programmable circuitry platform 1400 of the illustrated example includes programmable circuitry 1405. The programmable circuitry 1405 of the illustrated example is hardware. For example, the programmable circuitry 1405 can be implemented by one or more integrated circuits, logic circuits, FPGAs, microprocessors, CPUs, GPUs, DSPs, and/or microcontrollers from any desired family or manufacturer. The programmable circuitry 1405 may be implemented by one or more semiconductor based (e.g., silicon based) devices. In this example, the programmable circuitry 1405 implements the example network interface 205, the example unsafe condition monitoring circuitry 210, the example door locking circuitry 220, the example timing circuitry 225, the example gateway communication circuitry 230, and the example peripheral activation circuitry 250.

The programmable circuitry 1405 of the illustrated example includes a local memory 1410 (e.g., a cache, registers, etc.). The programmable circuitry 1405 of the illustrated example is in communication with main memory, which includes a volatile memory 1435 and a non-volatile memory 1440, by a bus 1425. Access to the main memory (e.g., the volatile memory 1435 and/or the non-volatile memory 1440) of the illustrated example is controlled by a memory controller 1430. In some examples, the memory controller 1430 may be implemented by one or more integrated circuits, logic circuits, microcontrollers from any desired family or manufacturer, or any other type of circuitry to manage the flow of data going to and from the main memory (e.g., the volatile memory 1435 and/or the non-volatile memory 1440).

The programmable circuitry platform 1400 of the illustrated example also includes interface circuitry 1445 which connects the programmable circuitry platform 1400 to other devices via the network 1450, input devices 1455 (e.g., input components), and output devices 1460 (e.g., output components).

The programmable circuitry platform 1400 of the illustrated example also includes one or more mass storage 1420 (e.g., one or more mass storage discs, one or more mass storage devices) which may implement the unsafe condition action plan data structure 215. The machine-readable instructions 1415, which may represent the machine-readable instructions 700, 800, 900, 1000, 1100, 1200, 1300, may be stored in the mass storage 1420, in the volatile memory 1435, in the non-volatile memory 1440, and/or on at least one non-transitory computer readable storage medium such as a CD or DVD which may be removable.

FIG. 15 illustrates that the programmable circuitry 1405 of FIG. 14 could be implemented by microprocessor circuitry 1500 which includes at least one core 1505. The microprocessor circuitry 1500 is able to execute the some or all of the machine-readable instructions of the flowcharts of FIGS. 7-13 to effectively instantiate the circuitry of FIG. 2 as logic circuits to perform operations corresponding to those machine-readable instructions. If the microprocessor circuitry 1500 includes multiple cores (such as in the example of FIG. 15), the machine-readable instructions may be executed in parallel. The cores 1505 obtain data, instructions, and/or signals which are processed with the control unit circuitry 1525, arithmetic and logic circuitry (e.g., AL circuitry 1530, an ALU, an arithmetic and logic unit) and stored with a plurality of registers 1535 and/or the local memory 1540. The cores 1505 may access a shared memory 1520 via a first bus 1510 and the interface circuitry 1515. Additionally, the core 1505 includes a second bus 1545 which connects the AL circuitry 1530, the control unit circuitry 1525, the registers 1535 and the local memory 1540.

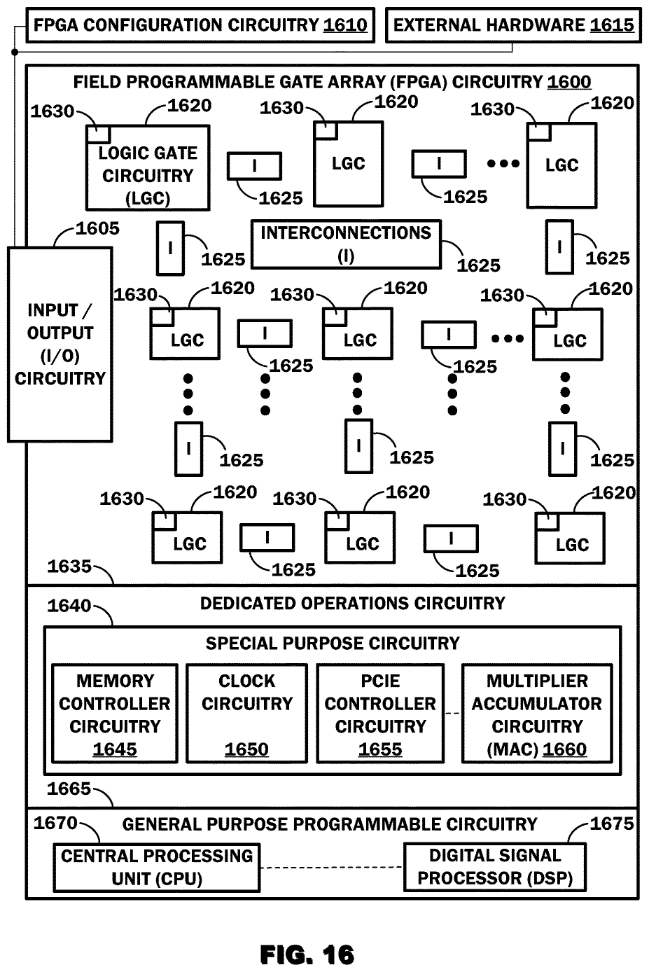

FIG. 16 illustrates that the programmable circuitry 1405 of FIG. 14 could be implemented by field programable gate array (FPGA) circuitry 1600 which is able to typically able to execute the operations and/or functions corresponding to the machine-readable instructions faster than a general-purpose microprocessor executing the corresponding software due to the machine-readable instructions being stored in hardware for the FPGA circuitry 1600. The FPGA circuitry 1600 may be thought of as an array of logic gates 1620 (e.g., And gates, Or gates, Nor gates, etc.), interconnections 1625, and switches. The switches can be programmed to change how the logic gates 1620 are interconnected by the interconnections 1625, effectively forming one or more dedicated logic circuits (unless and until the FPGA circuitry 1600 is reprogrammed). Storage circuitry 1630 of the illustrated example is structured to store result(s) of the one or more of the operations performed by corresponding logic gates 1620. Additionally, the FPGA circuitry 1600 includes input/output circuitry 1605 to receive configuration data from FPGA configuration circuitry 1610 and input data from the external hardware 61. The input/output circuitry 1605 is also to transmit output data to the external hardware 1615. Additionally, the dedicated operations circuitry 1635 includes special purpose circuitry 1640, which includes memory controller circuitry 1645, clock circuitry 1650, PCIE controller circuitry 1655, and multiplier accumulator circuitry 1660. The FPGA circuitry 1600 may additionally include general purpose programmable circuitry 1665 as implemented by a central processing unit 1670 and/or a digital signal processor 1675.

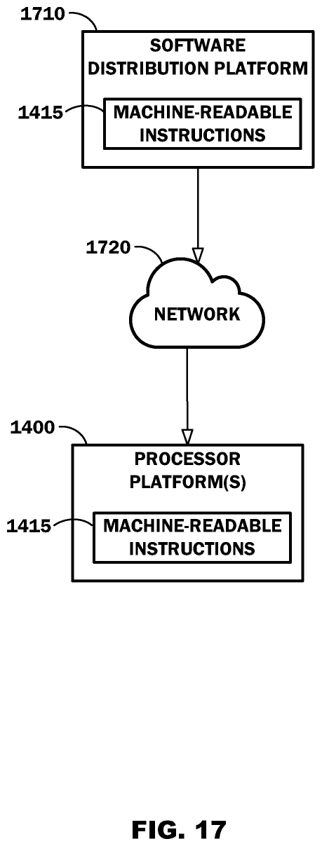

FIG. 17 is a block diagram of the example software distribution platform 1710 to distribute software, instructions, and/or firmware to client devices and/or hardware platform such as the programmable circuitry platform 1400 of FIG. 14. The software, instructions, and/or firmware may include the machine-readable instructions 1415 of FIG. 14 which correspond to the machine-readable instructions of the flowcharts of FIGS. 7-13. The software distribution platform 1710 may transmit the machine-readable instructions 1415 to the programmable circuitry platform 1400 via an example network 1720. Payment for the delivery, sale, and/or license of the software may be handled by the one or more servers of the software distribution platform and/or by a third-party payment entity.

From the foregoing, it will be appreciated that example systems, apparatus, articles of manufacture, and methods have been disclosed that improve the efficiency of a computing device by transmitting relevant data to one of a plurality of external devices from the personnel information system 165. This improves the efficiency of using the computing device because the external device receives the data without a query which uses processor power, network bandwidth, battery charge, and other computing resources.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A safety system in communication with at least one personnel information system that includes an occupant database, the at least one personnel information system operable to transmit a portion of occupant data from the occupant database to at least one external device, the safety system comprising:
an endpoint device to transmit an unsafe condition status to the at least one personnel information system based on detection of an unsafe condition, wherein the unsafe condition status causes the at least one personnel information system to transmit the portion of occupant data from the occupant database to the at least one external device.

2. The safety system of claim 1, wherein the endpoint device includes a plurality of sensors that are operable to detect the unsafe condition, and wherein the endpoint device is operable to transmit the unsafe condition status in response to at least one of the plurality of sensors detecting the unsafe condition.

3. The safety system of claim 2, wherein the endpoint device is to use a first one of the plurality of sensors to generate a first confidence score, and is to use a second one of the plurality of sensors to generate a second confidence score.

4. The safety system of claim 3, wherein if the first confidence score is underneath a first positive detection threshold and the second confidence score is underneath a second positive detection threshold, the endpoint device may use a combination of the first confidence score and the second confidence score to result in a positive detection.

5. The safety system of claim 1, wherein the endpoint device includes an unsafe condition action plan database that stores lockdown protocol information.

6. The safety system of claim 5, wherein the endpoint device is to classify the unsafe condition to generate an unsafe condition classification and, based on the unsafe condition classification, is to obtain a corresponding lockdown protocol action plan from the unsafe condition action plan database.

7. The safety system of claim 6, wherein the lockdown protocol action plan includes instructions for operating peripheral devices of the endpoint device and instructions for causing the endpoint device to transmit the unsafe condition status.

8. The safety system of claim 1, wherein the safety system is installed in a building and includes the at least one personnel information system, and wherein the occupant data includes information corresponding to a quantity of occupants in the building, an identity of occupants in the building, and an expected location of occupants in the building.

9. The safety system of claim 8, wherein the endpoint device is configured to, in response to detection of the unsafe condition, query the at least one personnel information system for at least some of the occupant data in the occupant database.

10. The safety system of claim 1, wherein the endpoint device is a first endpoint device, the safety system further comprises a second endpoint device, wherein the detection of the unsafe condition is performed by the second endpoint device.

11. The safety system of claim 10, wherein the system is installed in a building, wherein the first endpoint device is located in a first room in the building, and wherein the second endpoint device is located in a second room in the building.

12. The safety system of claim 1, wherein the endpoint device includes at least one of: a display, an auditory speaker, a visual light video-camera, a non-imaging visual light sensor, a first microphone operable to detect human speech, a second microphone operable to detect sounds in a decibel range higher than a decibel range associated with human speech, an infrared light video-camera, a non-imaging infrared light sensor, a particulate matter detector, a clock, a flasher, a thermal camera, a thermometer, a smoke detector, and an occupancy detector.

13. The safety system of claim 1, further comprising a wireless communication router in communication with the endpoint device, and wherein the endpoint device is operable to command the wireless communication router to establish a wireless network based on detection of an unsafe condition.

14. The safety system of claim 13, wherein the wireless communication router is to transmit video based on the detection of the unsafe condition.

15. An apparatus installed in a building, the building having a personnel information system, the apparatus comprising:
at least one sensor to generate sensor data;
unsafe condition monitoring circuitry to, based on the sensor data, determine that an unsafe condition is present in the building; and
a network interface to transmit an alert to the personnel information system.

16. The apparatus of claim 15, further including an auditory speaker and peripheral activation circuitry, wherein the peripheral activation circuitry is to activate an auditory alarm with the auditory speaker based on the determination that the unsafe condition is present in the building.

17. The apparatus of claim 15, further including a flasher, an internal front display, and peripheral activation circuitry, wherein the peripheral activation circuitry is to activate a visual alarm with the flasher and a text-based alarm with the internal front display based on the determination that the unsafe condition is present in the building.

18. The apparatus of claim 15, wherein the alert is to instruct the personnel information system to transmit occupant data to at least one external device.

19. The apparatus of claim 15, wherein the apparatus further includes door locking circuitry, wherein the door locking circuitry is to transmit a door locking instruction that is operable to cause locking of remotely lockable doors.

20. An apparatus installed in a building, the apparatus comprising:
an occupant database to store occupant information including information relating to a quantity of occupants in the building, an identity of occupants in the building, and an expected location of occupants in the building; and
a network interface to transmit a portion of the occupant information to at least one external device.

21. The apparatus of claim 20, further including door locking circuitry operable to lock or unlock remotely lockable doors in the building.

22. The apparatus of claim 20, wherein the at least one external device includes a first external device and a second external device, and wherein the apparatus is to transmit a first data message to the first external device and a second data message to the second external device.

23. The apparatus of claim 22, wherein the network interface is to use a location signal of the at least one external device to determine if the at least one external device is an on-premise external device, located within the building, or an off-premise external device, located outside of the building.

24. The apparatus of claim 20, wherein the building includes at least one endpoint device operable to send a query corresponding to information regarding a total quantity of occupants in the building, wherein the quantity of occupants in the building includes the total quantity of occupants in the building, and wherein the network interface is to receive the query.

25. The apparatus of claim 20, wherein the network interface is to transmit the portion of the occupant information through at least a subset of a plurality of channels, the plurality of channels including at least one of a text message channel, an email channel, a social media channel, a cellular phone call channel, an internet phone call channel, and a user application notification channel.
